(19) United States
(12) Patent Application Publication
(10) Pub. No.: US 2026/0074290 A1
(43) Pub. Date: Mar. 12, 2026

(54) Nonflammable Electrolytes For Potassium Batteries

(71) Applicant: The Trustees of Columbia University in the City of New York, New York, NY (US)

(72) Inventors: Andrew Ells, Blue Bell, PA (US); Pablo Buitrago Botero, New York, NY (US); Lauren Marbella, New York, NY (US)

(21) Appl. No.: 19/324,424

(22) Filed: Sep. 10, 2025

Related U.S. Application Data
(60) Provisional application No. 63/694,125, filed on Sep. 12, 2024.

(51) Int. Cl. H01M 10/0568; H01M 4/583; H01M 10/054; H01M 10/0567; H01M 10/0569

(52) U.S. Cl. CPC H01M 10/0568; H01M 4/583; H01M 10/054; H01M 10/0567; H01M 10/0569; H01M 2220/20; H01M 2300/0037

(57) ABSTRACT

An electrolyte, comprising: an amount of potassium hexafluorophosphate; at least one cyclic carbonate, the at least one cyclic carbonate optionally comprising at least one of ethylene carbonate and propylene carbonate; and at least one organic phosphate, the at least one organic phosphate optionally comprising at least one of trimethyl phosphate and triethyl phosphate. An electrical cell, comprising: the electrolyte according to the present disclosure, and an electrode, the electrode contacting the electrolyte. A method, comprising: any one or more of separating, disposing, or at least partially neutralizing any one or more of HF, HPO₂F₂, H₂PO₃F, an organofluorophosphate, a monofluorophosphate, an organophosphate, and a phosphonate evolved from operating an electrical cell that includes as an electrolyte any one or more of LiPF₆, NaPF₆, and KPF₆.

### RELATED APPLICATIONS

The present application claims priority to and the benefit of U.S. patent application No. 63/694,125, “Nonflammable Electrolytes For Potassium Batteries” (filed Sep. 12, 2024). All foregoing applications are incorporated herein by reference in their entireties for any and all purposes.

### GOVERNMENT RIGHTS

This invention was made with government support under OD026749 awarded by the National Institutes of Health, and 2116728 awarded by the National Science Foundation. The government has certain rights in the invention.

### TECHNICAL FIELD

The present disclosure relates to the field of battery electrolytes, in particular the field of battery electrolytes useful in potassium batteries.

### BACKGROUND

Certain battery electrolytes exhibit certain sub-optimal characteristics, including flammability and evolution of unwanted byproducts. Accordingly, there is a need in the art for improved battery electrolytes.

### SUMMARY

In meeting the described long-felt needs, the present disclosure provides an electrolyte, comprising: an amount of potassium hexafluorophosphate; at least one cyclic carbonate, the at least one cyclic carbonate optionally comprising at least one of ethylene carbonate and propylene carbonate; and at least one organic phosphate, the at least one organic phosphate optionally comprising at least one of trimethyl phosphate and triethyl phosphate.

Also provided is an electrical cell, comprising: the electrolyte according to the present disclosure, and an electrode, the electrode contacting the electrolyte.

Also disclosed is a method, comprising: charging or discharging an electrical cell according to the present disclosure.

Additionally provided is a method, comprising: any one or more of separating, disposing, or at least partially neutralizing, any one or more of HF, HPO₂F₂, H₂PO₃F, an organofluorophosphate, a monofluorophosphate, an organophosphate, and a phosphonate evolved from operating an electrical cell that includes, as an electrolyte, any one or more of LiPF₆, NaPF₆, and KPF₆.

Also disclosed is a method, comprising: mitigating the effects of any one or more of HF, HPO₂F₂, H₂PO₃F, an organofluorophosphate, a monofluorophosphate, an organophosphate, and a phosphonate evolved from operating an electrical cell that includes as an electrolyte any one or more of LiPF₆, NaPF₆, and KPF₆.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Flame tests of glass fiber separators soaked in (a) EC/PC and (b) EC/PC with 20 vol % TEP. (c) Various time points of a vapor flammability test at 200° C. for EC/DEC with 20 vol % TEP (left) and EC/PC with 20 vol % TEP (right). The white ring highlights a self-sustaining flame from vapor ignition in the electrolyte that contains DEC.

FIG. 2. (a) Galvanostatic cycling of graphite half cells with one formation step at C/20 and subsequent cycles at C/5. Points are the average of two cells with standard error represented via bars. The theoretical capacity of graphite is plotted as the black dashed line. (b) Voltage profiles of the formation (solid lines) and first C/5 cycle (dashed lines) for K∥Gr half cells cycled in 1 M KPF₆ EC/PC (black) and with 20 vol % TEP (green).

FIG. 3. EIS of symmetric Gr∥Gr cells after one C/20 formation step. Cells were cycled in 1 M KPF₆ with EC/PC (black) or EC/PC with 20 vol % TEP (green). Fits were generated using a Randles circuit (shown bottom right) and are plotted as solid lines.

FIG. 4. Ex situ XPS of graphite anodes cycled opposite K metal for 20 cycles. (a) C is spectra of 1 M KPF₆ EC/PC (top) and with 20 vol % TEP (bottom). (b) O is spectra of 1 M KPF₆ EC/PC (top) and with 20 vol % TEP (bottom). Raw data is shown as gray dots; the summed peak envelope is shown as a transparent green line.

FIG. 5. (a) 1D ³¹P NMR and (b) 2D ¹H-³¹P HMQC NMR of a graphite electrode cycled in 20% TEP from 0 to 1 V for 5 cycles, then dissolved in 1:1 D₂O:H₂O. The TEP peak is truncated to magnify the intensity of the phosphate decomposition product.

FIG. 6. Voltage profile during C/20 formation cycle for K∥Gr or Li∥Gr half cells cycled with 1 M KPF₆ (green) and 1 M LiPF₆ (blue) in EC/PC with 20 vol % TEP. A refers to either the K or Li reference electrode.

FIG. 7. ¹⁷O solution NMR cropped to the carbonyl oxygen peak of the “neat” EC/PC with 20 vol % TEP solvent (bottom, black), with 1 M KPF₆ added (middle, green), and 1 M LiPF₆ added (top, blue). Upfield shifts (towards negative ppm) indicate shielding of lone pair electrons on carbonyl ¹⁷O nucleus due to coordination with the alkali cation. Stronger coordination results in a greater upfield shift. Spectra were collected at 50° C. to counter quadrupolar line broadening.

FIG. 8. Specific discharge capacities of K∥Gr or Li∥Gr cells that underwent one formation step at C/20 and then cycled at C/5. Voltage bounds were 0 and 2 V. Average capacities and error bars shown are representative of two cells.

FIG. 9. Ex situ XRD of graphite electrodes removed from K∥Gr coin cells extracted at the end of discharge (potassiation) after cycling at different rates.

FIG. 10 Raman spectroscopy of graphite electrodes. Cycled samples were extracted from cells fully depotassiated after 20 cycles. Cells were cycled with 1 M KPF₆ EC/PC with (green) or without (black) 20 vol % TEP. The G band at 1580 nm⁻¹ denotes sp² graphitic carbon and the D band at 1330 nm⁻¹ is assigned to A_{1g} disordered carbon. Higher D/G ratio is attributed to structural breakdown of graphite.²

FIG. 11. XPS of P 2p orbital for depotassiated graphite electrodes after 20 cycles in 1 M KPF₆ EC/PC without TEP (left) or with 20 vol % TEP (right). Peaks are assigned to P—F from residual KPF₆ or P—O from KₓPO_{y}F_{z} or potassium phosphate salts.

FIG. 12. ³¹P solution NMR of uncycled graphite electrode assembled with 1 M KPF₆ EC/PC with 20 vol % TEP, then immediately removed and dissolved in 1:1 H₂O:D₂O. The TEP peak is truncated and spectrum axes are adjusted to the region where phosphate decomposition products would resonate (˜1 ppm).

FIG. 13. Full ³¹P solution NMR of K∥Gr cell cycled in 20% TEP electrolyte after 5 CV cycles between 0 and 1 V. The graphite electrode was extracted and then dissolved in 1:1 H₂O:D₂O.

FIG. 14. ³¹P solution NMR of K∥Gr cell cycled with EC/PC electrolyte after 5 CV cycles between 0 and 1 V. The graphite electrode was extracted and then dissolved in 1:1 H₂O:D₂O. Peaks corresponding to PF₆⁻ are truncated; the axes are adjusted to show no phosphate decomposition products above baseline noise.

FIG. 15. ¹⁹F solution NMR of K∥Gr cell cycled with either 20% TEP (blue) or EC/PC (black) electrolyte after 5 CV cycles between 0 and 1 V. The graphite electrode was extracted and then dissolved in 1:1 H₂O:D₂O. Peaks corresponding to PF₆⁻ are truncated.

FIG. 16. XPS of F is orbital for depotassiated graphite electrodes after 20 cycles in 1 M KPF₆ EC/PC without TEP (left) or with 20 vol % TEP (right). Peaks are assigned to F—P from residual KPF₆ or KF.

FIG. 17. Voltage profile during C/20 formation cycle for K∥Gr half cells cycled with 1 M KPF₆ in TEP.

FIG. 18. XPS of graphite electrodes contacted with electrolyte but not cycled.

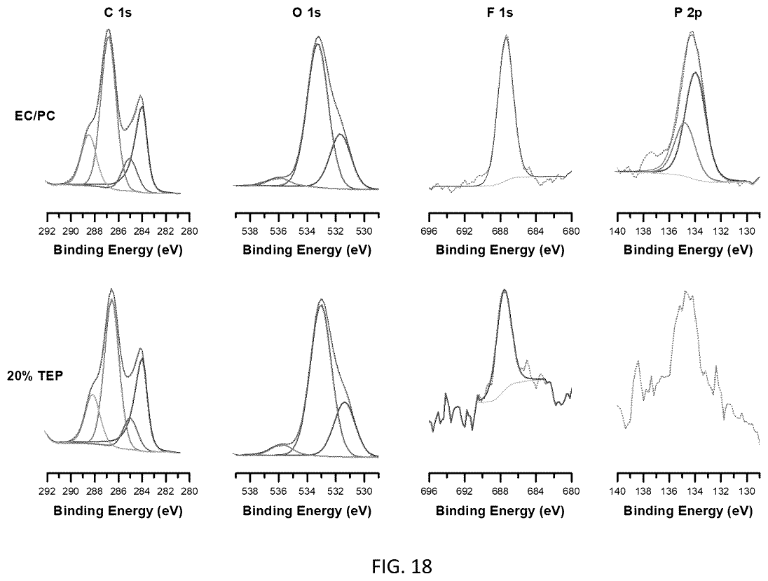

FIG. 19. In situ ¹⁹F NMR spectra of (a) 1 M KPF₆, (b) 1 M NaPF₆, and (c) 1 M LiPF₆ in 1:1 ethylene carbonate:propylene carbonate (EC:PC) collected over the course of approximately one month before (pristine, light orange, bottom) and after the addition of 1.5 vol % H₂O. The most intense peaks (PF₆⁻; HF at the end of the Li experiment) have been truncated to visualize the decomposition products. The inset in (b) magnifies the region that corresponds to PO₂F₂⁻, which is present in the pristine NaPF₆ electrolyte.

FIG. 20. In situ (a) ¹⁹F and (b) ³¹P{¹H}NMR spectra of 1 M LiPF₆ in EC:PC collected before and after 1.5 vol % H₂O addition. Magnified slice of in situ (c)¹⁹F and (d) ³¹P{¹H} NMR from (a, b) after aging 1 M LiPF₆ in EC:PC in 1.5 vol % H₂O for 24 days. The spectra shown in (c) and (d) include assignments for the different chemical species that arise from PF₆⁻ decomposition; note that the high intensity PF₆⁻ peak in ¹⁹F NMR is truncated to allow visualization of minor species.

FIG. 21. Two-dimensional (2D) (a) ¹⁹F-³¹P HMQC and (b) ³¹P-¹H HMQC of 1 M LiPF₆ in EC:PC with 1.5 vol % H₂O collected at 71 days. Note that in the ¹⁹F-³¹P HMQC, the high intensity PO₂F₂⁻ signal in (a) shows t₁ artifacts and not a triplet pattern. (c)¹H decoupled (i.e., ³¹P{¹H})³¹P NMR and (d)³¹P NMR with no ¹H decoupling of 1 M LiPF₆ in EC:PC with 1.5 vol % H₂O collected at 276 days facilitate the assignment of functional groups shown in Table 1. Note that aging for 276 days has led to slight changes in chemical shift (±0.2 ppm) compared to 71 days, likely due to changes in the surrounding environment as a result of degradation.

FIG. 22. (a) Change in the concentration of chemical species in the 1 M LiPF₆ EC:PC+1.5 vol % H₂O electrolyte over time. (b) Magnification of the data in (a) showing the lower concentration decomposition products. Lines are included between dots as guides to the eye. Individual organofluorophosphates (OFPs) and organophosphates (OPs) were summed together and plotted.

FIG. 23. In situ ¹⁹F NMR of 1 M (a, c) NaPF₆ and (b, d) KPF₆ EC:PC electrolytes as well as concentrations of different chemical components as a function of time derived from integrated NMR intensities after addition of 1.5 vol % of 37% HCl. The NMR time series data increases as a function of time going from light orange to dark brown and each spectra in (a) matches a time point in (c); (b) in (d).

FIG. 24. In situ ³¹P NMR spectra of (a) 1 M KPF₆, (b) 1 M NaPF₆, and (c) 1 M LiPF₆ in 1:1 ethylene carbonate:propylene carbonate (EC:PC) collected over the course of approximately one month before (pristine, light orange, bottom) and after the addition of 1.5 vol % H₂O. The most intense peaks (PF₆; PO₃F at the end of the Li experiment) have been truncated to visualize the decomposition products.

FIG. 25. ¹⁹F NMR spectrum of 1 M KPF₆ in EC:PC with 1.5 vol % added H₂O after 140 days of storage. Inset shows the magnified region that corresponds to the chemical shift range for HF as a dissociated ion and its various coordination complexes.

FIG. 26. ¹⁹F and ³¹P NMR spectra of pristine, as made 1 M KPF₆ (bottom, black), 1 M KPF₆ after one month at 60° C. (middle, red), and 1 M LiPF₆ after one month at 60° C. (top, green), all in EC:PC.

FIG. 27. ¹H NMR of 1 M KPF₆ in EC:PC+1.5 vol % H₂O at 33 days showing the formation of ethylene glycol (EG), a hydrolysis product of EC.

FIG. 28. Change in concentration of chemical species in the (a, b) 1 M NaPF₆ and (c, d) 1 M KPF₆ EC:PC+1.5 vol % H₂O electrolyte as a function of time. (b) and (d) are magnifications of the data in (a) and (c), respectively.

FIG. 29. ¹⁹F NMR of 0.33 M HF in water (top, red) and 0.38 M HF in LP30 (1 M LiPF₆ in EC:DMC) (bottom, blue) showing the difference in chemical shift as a function of solvent.

FIG. 30. ¹⁹F-³¹P HMQC of 1 M LiPF₆ in 1:1 ECPC with 1.5 vol % H₂O collected at 71 days, zoomed in on PF₆⁻ region.

FIG. 31. ¹H-¹H correlation spectroscopy (COSY) of 1 M LiPF₆ in EC:PC with 1.5 vol % H₂O after 71 days. The cross peak for the propyl alcohol functional group is highlighted in pink.

FIG. 32. ³¹P-³¹P COSY of 1 M LiPF₆ in EC:PC with 1.5 vol % H₂O after 71 days, showing no cross peaks, suggesting the absence of P—O—P linkages characteristic of polyphosphates.

FIG. 33. ¹⁹F NMR spectrum of 1 M LiPF₆ in EC:PC with 1.5 vol % H₂O after 71 days, with a higher irradiation frequency to probe for C—F environments (see methods section).

FIG. 34. ¹⁹F NMR and ³¹P NMR spectra of 1 M LiPF₆ in EC:PC with 200 ppm H₂O recorded after 77 days.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Within the nascent field of K-ion batteries (KIBs), electrolyte design principles generally follow the examples set by Li- and Na-ion chemistries. To that effect, recent efforts have focused on developing safe, nonflammable electrolytes utilizing triethyl phosphate (TEP) that were first explored in Li- and Na-ion batteries. To be compatible with graphite as the sole solvent, TEP must be mixed with high concentrations (≥2 M) of potassium bis(fluorosulfonyl)imide (KFSI). However, high salt concentrations have many drawbacks for practical batteries (e.g., low ionic conductivity and high cost). In this report, we show that a low-concentration (1 M) KPF6 electrolyte combining ethylene carbonate (EC), propylene carbonate (PC), and TEP is nonflammable, retains high ionic conductivity, and is compatible with graphite. Notably, we then show that this electrolyte is only usable in KIBs; the analogous Li electrolyte fails immediately due to the incompatibility of Li, PC, and graphite. We continue the study by characterizing the impact of TEP on the graphite interphase using a combination of electrochemical impedance spectroscopy (EIS), X-ray photoelectron spectroscopy (XPS), and 1D and 2D nuclear magnetic resonance spectroscopy (NMR). We show that, compared to using EC/PC alone, the addition of TEP reduces resistance of the solid electrolyte interface (SEI) layer, lessens reductive decomposition of carbonates to soluble organic species, and produces inorganic phosphate salts (that one can posit contribute to passivation in lieu of fluorination in the SEI).

The transition to a renewable energy ecosystem requires widespread, affordable electrochemical energy storage for grid and transportation applications. Li-ion batteries (LIBs) currently dominate the commercial energy storage market, but supply chain concerns for lithium and other critical minerals motivate the development of new battery chemistries. Na-ion batteries have subsequently been studied, but longevity and volumetric energy density concerns have slowed rapid adoption.5,6 K-ion batteries (KIBs) offer compelling advantages as a Li alternative. K can reversibly intercalate into graphite while Na cannot, enabling an anode that is already commercialized at scale. The most compelling cathodes for KIBs, Prussian blue analogues, offer high voltage cycling and rate capability using abundant transition metals, and efforts to commercialize are underway.

Development of K-ion electrolytes is still a nascent effort. K-ions are weaker Lewis acids than Li-ions, leading to lower solvation energies, smaller Stokes radii, and increased reductive stability of anions compared to LIB electrolytes. These fundamental differences have multifaceted influence on battery performance. For example, time-of-flight secondary ion mass spectrometry (TOF-SIMS) analysis shows the solid electrolyte interphase (SEI) layer formed from electrolyte decomposition on graphite differs significantly from Li to K, with the K-based SEI forming more organic and less fluorinated SEI components. We have observed limited KPF₆ decomposition to inorganic SEI components, if any. In addition, the smaller solvation shell of K compared to Li has been attributed to higher salt diffusion coefficients and cation transference numbers, as well as lower desolvation energy, suggesting K electrolytes can enable high rate capabilities.

Recently, electrolytes containing high concentrations of bisfluorosulfonyl(imide) (FSI) salts in triethyl phosphate (TEP) have gained popularity in alkali metal-ion batteries for their ability to suppress electrolyte ignition through a radical trap/gas phase mechanism. In fact, 2 M KFSI in TEP is widely considered the preeminent electrolyte for KIBs. However, these electrolytes still suffer from the drawbacks of high-concentration electrolytes (HCEs), including high viscosity, low ionic conductivity, and high salt cost, sacrificing many of the benefits touted for KIBs. Unfortunately, low concentration (˜1 M) electrolytes with TEP are incompatible with graphite anodes due to the inability to form a passivating SEI and/or co-intercalation.

In this disclosure, we find that the addition of 20 vol % TEP to cyclic carbonate electrolytes improves the safety profile and performance of KIBs, representing a new design space for beyond Li-ion systems. We demonstrate the favorable intrinsic properties of the solvent mix: it does not ignite, its vapors are nonflammable, and it has higher ionic conductivity than 2 M KFSI TEP. In graphite half cells, we find the 20 vol % TEP electrolyte significantly improves capacity retention over 1 M KPF₆ ethylene carbonate:propylene carbonate (EC/PC 1:1 v/v). Investigating this phenomenon, electrochemical impedance spectroscopy (EIS) of symmetrical graphite cells suggests that TEP reduces charge transfer resistance. We use a combination of X-ray photoelectron spectroscopy (XPS) and ex situ 31P and 19F solution NMR to characterize the graphite SEI, finding that the TEP cosolvent reduces to inorganic potassium salts in the SEI and results in lower content of poorly-passivating, soluble organic phases from carbonate reduction.

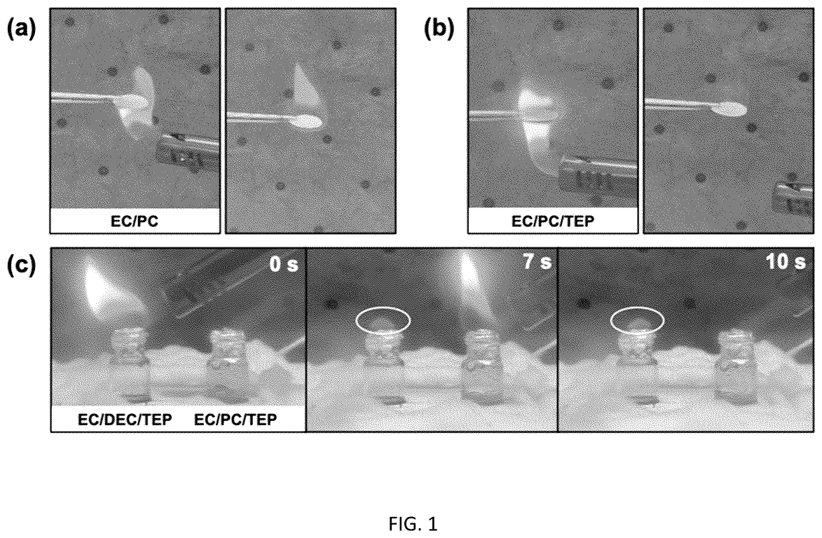

We begin by assessing the safety advantages of utilizing EC/PC rather than the conventional mix of EC and a linear carbonate such as diethyl carbonate (DEC). Because EC and PC have the lowest volatility of conventional carbonate solvents, they require the lowest concentration of flame retardant to make a nonflammable mixture. In a flame test where glass fiber separators were soaked in electrolyte and ignited (FIGS. 1a-b), we found that the self-extinguish time (the duration of a self-sustaining flame per unit mass of electrolyte) of 1 M KPF₆ EC/PC is 109 s g-1 and that adding >10 vol % TEP prevents combustion outright. Therefore, a solvent mix of 1 M KPF₆ EC/PC with 20 vol % TEP was selected for this study. In addition to a 0 s g-1 self-extinguish time, EC/PC offers advantages in vapor flammability. FIG. 1c illustrates a vapor flammability test, in which one mL of EC/DEC and EC/PC with 20 vol % TEP additive were heated to 200° C. to generate significant vapor pressure. After holding a torch to both vials, the vapors from the EC/DEC/TEP electrolyte sustain a constant flame (FIG. 1c, left vial), likely due to the high vapor pressure of DEC relative to EC and TEP. In contrast, the vapors of EC/PC/TEP are nonflammable (FIG. 1c, right vial), likely because TEP boils at a lower temperature than EC/PC, and is known to suppress ignition even in vapor phase.

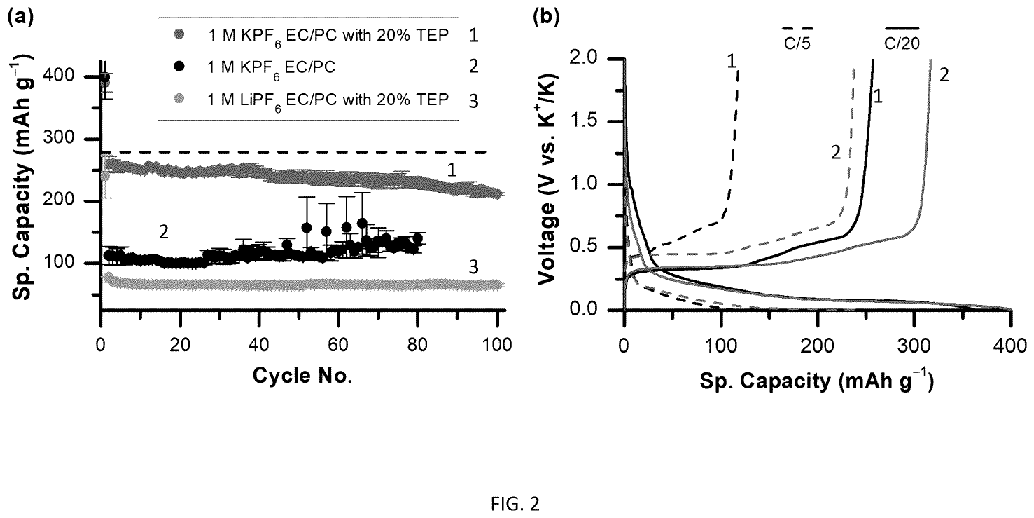

To evaluate the impact of 20 vol % TEP on battery performance, graphite half cells (abbreviated K∥Gr) were subject to one formation cycle at C/20 and then 100 cycles at C/5 with upper and lower voltage cutoffs of 2 and 0 V, respectively. Specific discharge capacities for cells assembled with 1 M KPF₆ EC/PC (black, hereon abbreviated to “EC/PC”) and with 1 M KPF₆ EC/PC with 20 vol % TEP (green, hereon abbreviated to “20% TEP”) are shown in FIG. 2a. In the C/20 formation step, 20% TEP outperforms EC/PC, with higher initial coulombic efficiency (ICE) of 79% compared to 72%. When current increases to C/5 for the rest of cycling, 20% TEP can access a much higher capacity (260 mAh g-1 compared to 113 mAh g-1 for EC/PC). Over time, capacity slowly fades in the 20% TEP electrolyte to 206 mAh g-1 by the 100th cycle. Comparatively, EC/PC cells maintain low capacity and exhibit erratic capacity that initially fades, then slowly increases with sporadic spikes. Eventually, cycling became so erratic that cells were removed from the cycler prior to 100 cycles.

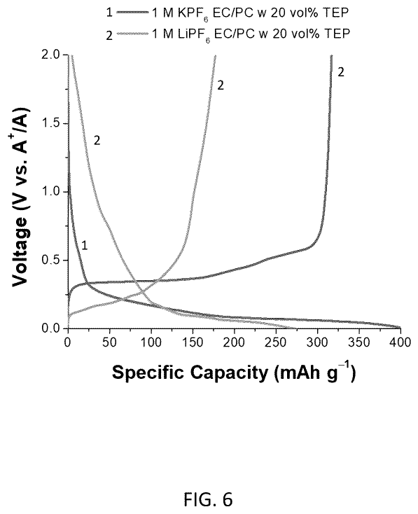

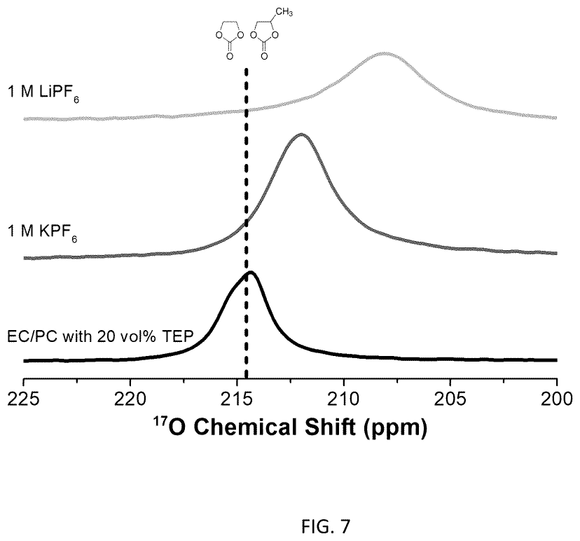

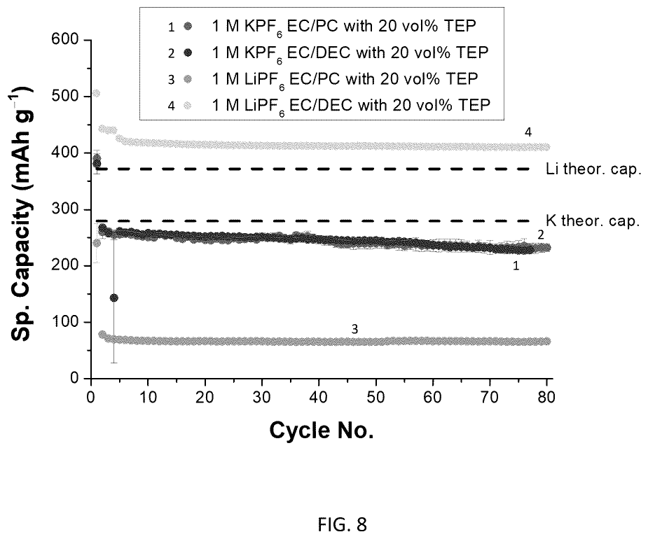

We note that the compatibility of graphite with EC/PC and 20 vol % TEP is unique to KPF₆. FIG. 2a includes the capacity of Li∥Gr cells assembled with the analogous LiPF₆ electrolyte (light blue). The capacity immediately drops to ˜70 mAh g-1 and remains low for 100 cycles. Voltage profiles (FIG. 6) and 17O spectra (FIG. 7) indicate stronger coordination of Li+ to PC, resulting in co-intercalation and continuous SEI formation. These phenomena are well-documented for high PC-content electrolytes. The unique compatibility of K+ and PC with graphite is further highlighted in FIG. 8; replacing PC with DEC increases accessible capacity in LIBs but has no effect on capacity in KIBs (as discussed, solvent mixes with DEC are undesirable due to flammability concerns).

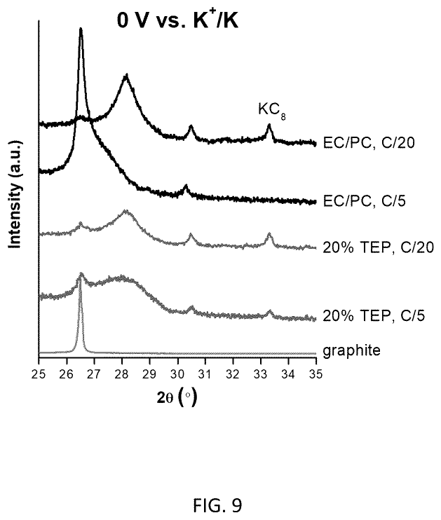

The voltage profiles shown in FIG. 2b aid in explaining how 20% TEP (green) enables higher capacity cycling in K∥Gr cells. In the formation step, the shape of the potassiation and depotassiation profiles look similar for both 20% TEP and EC/PC, though the higher ICE is clearly evident for 20% TEP. When the current increases to C/5, cell overpotential increases and the onset potential of potassiation drops 100 mV in both EC/PC and 20% TEP cells. However, the 20% TEP cells retain the potassiation voltage plateau, whereas the EC/PC profile is highly sloped and reaches the lower cutoff voltage lower capacity. During depotassiation, the same 100 mV overpotential is observed, and the initial voltage plateau (now at 0.44 V) is only observed for the 20% TEP cells. This suggests that the final, high-capacity phases of graphite potassiation (i.e., KC8) form when cycling in 20% TEP but not when cycling in EC/PC. We confirmed this via ex situ XRD of potassiated graphite (FIG. 9). After C/5 discharge to 0 V, the reflection at 33.3° for KC8 formation is only observed in cells cycled in 20% TEP, in addition to reflections at 28.2° consistent with early-stage graphite-intercalated compounds (GICs). As expected, graphite cycled in EC/PC shows a prominent reflection at 26.5° consistent with pristine graphite and no reflection for KC8, indicative of incomplete potassiation.

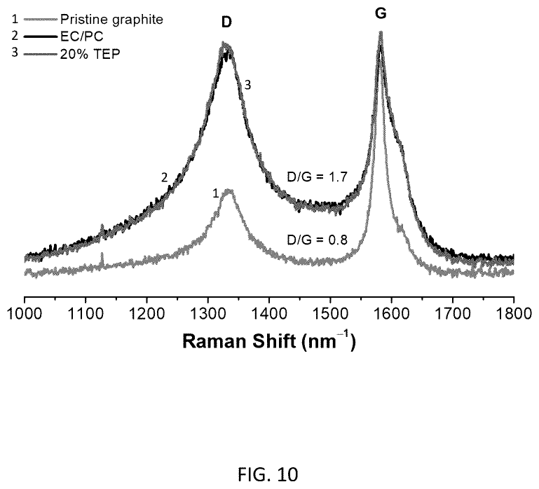

Graphite cycled in 20% TEP is clearly better able to retain capacity at higher current densities. We assessed bulk characteristics of cell components as the underlying cause; however, at room temperature the ionic conductivity of 20% TEP slightly decreases to 8.0 mS cm-1 from 9.2 mS cm-1 measured for EC/PC (though still much higher than 5.1 mS cm-1 recorded for 2 M KFSI TEP). Additionally, Raman spectroscopy shows that graphite electrodes cycled in either electrolyte have similar quantity of disordered phases generally attributed to capacity fade (FIG. 10). These data suggest the improvement in rate capability lies in improved charge transfer at the graphite surface, potentially due to changes in SEI composition after TEP addition.

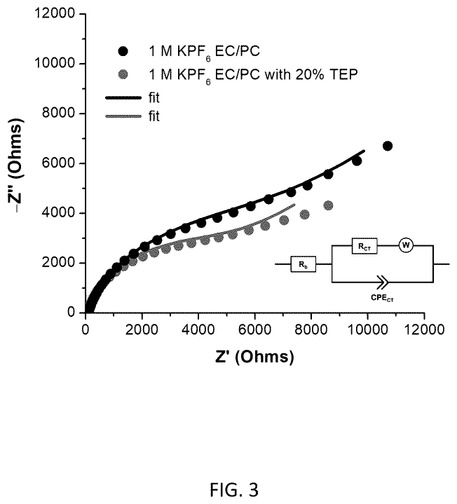

To observe changes to charge transfer resistance from the SEI, we conducted potentiostatic EIS. K∥Gr cells underwent formation at C/20, then potassiation to ˜50% state-of-charge (SOC) at 0.1 V and were held at constant voltage for two hours. The K∥Gr cells were then disassembled and reassembled as symmetrical Gr∥Gr cells to isolate the impedance spectra for graphite (this was preferred over three-electrode EIS, as K metal is believed to be a reactive and unsuitable reference electrode34,35). The results are shown in FIG. 3. One dominant semicircle assigned to the charge transfer impedance is observed and encompasses both diffusion through the SEI and K-ion solvation/desolvation. Fitting the collected EIS spectra to a simple Randles circuit (FIG. 3 inset), RCT is found to be 2467 Ohms with 20% TEP and 3376 Ohms with EC/PC (note: RCT values from the fit are divided in half to find the single electrode impedance, full fit parameters and errors are listed in Table 2).

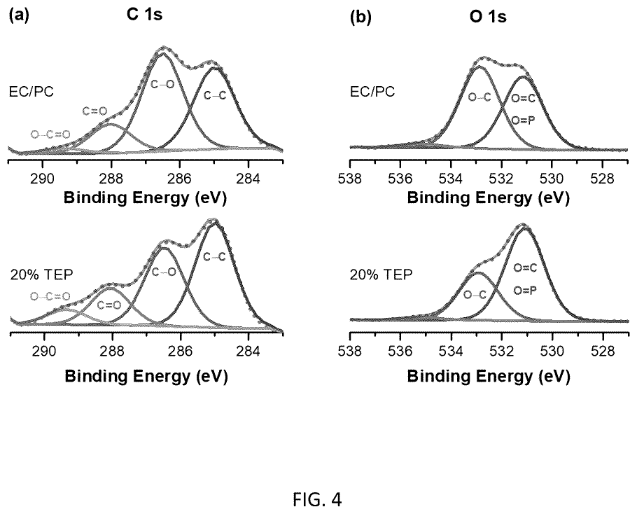

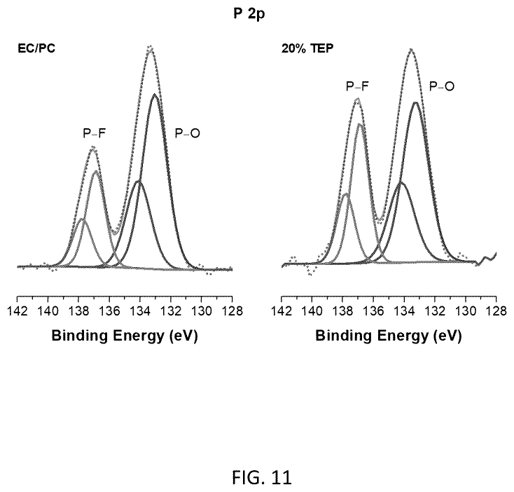

To determine how TEP alters the SEI, we characterized the surface layer formed on graphite electrodes after 20 cycles using air-free XPS. FIG. 4a shows that cycling in the EC/PC electrolyte increases the proportion of C—O bonds (286.5 eV) observed in C is orbital by 50% compared to cycling in 20% TEP (all XPS peak assignments and fractional abundances are listed in Table 3), indicating much higher content of soluble, poorly-passivating organic phases such as poly(ethylene oxide) (PEO) and potassium alkoxides (ROK). The accumulation of C—O species suggests increased SEI accumulation from carbonate reduction, consistent with the low ICE observed during cycling. The O is spectra in FIG. 4b show TEP addition results in a 40% increase in the proportion of highly oxygenated species (531.1 eV). The minority contribution of O—C=O and C=O to the C is spectrum indicates that the O is peak at 531.1 eV is therefore likely made up of other phases, such as phosphates. P 2p spectra (FIG. 11) for both electrolytes have two doublets, corresponding to residual KPF₆ and phosphate species. Distinguishing between fluorophosphates from KPF₆ breakdown (potentially present in both electrolytes) and phosphates produced from TEP reduction is not possible with XPS.

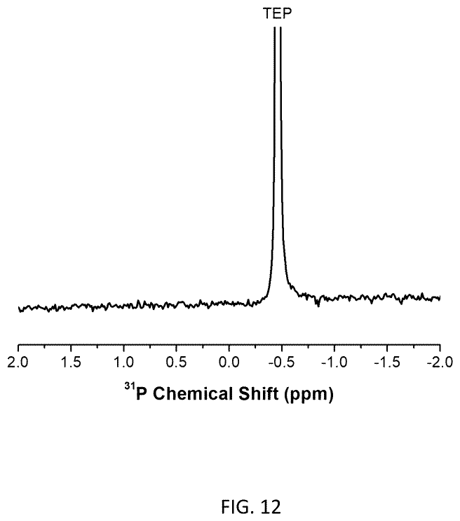

Higher chemical resolution of the phosphorous-containing SEI species is achieved via NMR spectroscopy. To generate a detectable quantity of electrolyte decomposition products for solution NMR, we constructed a K∥Gr coin cell with high graphite mass loading (7 mg cm-2). We conducted cyclic voltammetry (CV) on the cell at very low scan rate (0.01 mV/s) between 0 and 1 V for 5 cycles. After disassembling the cell, we dissolved the graphite electrode in a 1:1 H2O:D2O mixture. Control experiments using an uncycled graphite electrode and pristine electrolyte yielded 31P NMR signal from solely TEP and KPF₆ (FIG. 12). Therefore, one can have at least some confidence that peaks in 31P NMR spectrum of the dissolved sample originate the graphite interphase and not electrolyte hydrolysis.

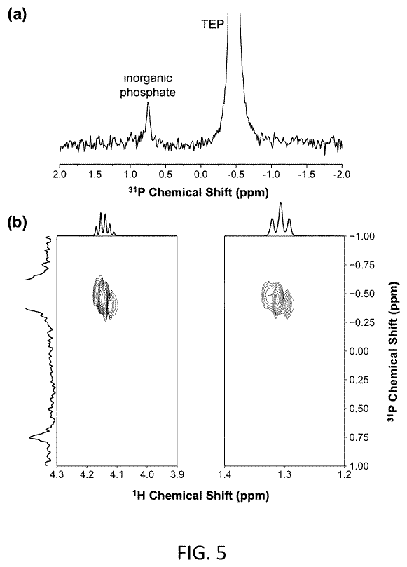

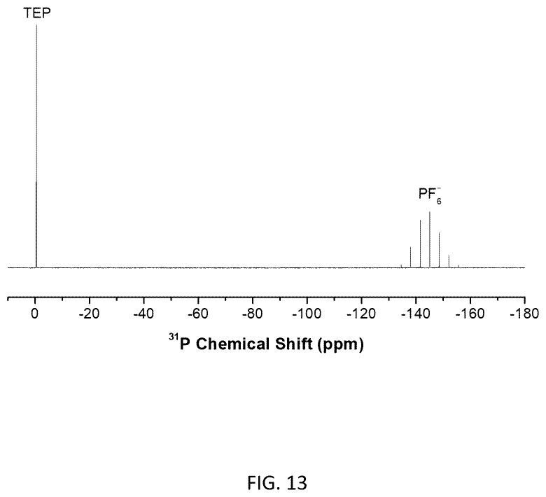

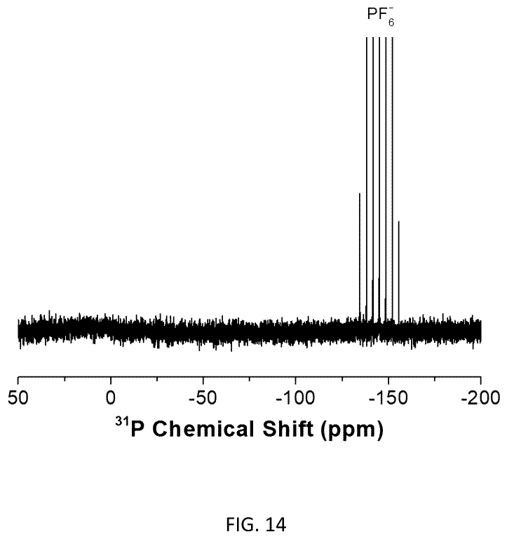

In the 31P NMR shown in FIG. 5a, we observe two singlets near 0 ppm (full spectrum shown in FIG. 13). The largest singlet at −0.46 ppm is assigned to TEP. The other singlet appears slightly upfield of TEP at 0.77 ppm, consistent with increased shielding on the central P nucleus from reductive decomposition of TEP to an inorganic potassium phosphate salt.39 (Note that this peak at 0.77 ppm is not observed in the control EC/PC electrolyte (FIG. 14), supporting that it is a byproduct of TEP). To confirm if the TEP reduction product is an organophosphate or free phosphate anion, we conducted 2D 31P{1H}heteronuclear multiple quantum correlation (HMQC) NMR (FIG. 5b). In this experiment, the peaks that appear represent 31P nuclei coupled to nearby 1H nuclei. For example, the 31P singlet for TEP at −0.46 ppm yields 2D correlated cross-peak intensities at 4.1 ppm (dq, JH-P=1 Hz) and 1.3 ppm (dt, JH-P=0.9 Hz) in the 1H spectrum, representing the ethyl and methyl protons in the alkyl chains, respectively. There is no observed signal intensity for the 31P singlet at 0.77 ppm, suggesting no nearby 1H from alkyl chains. Therefore, we assign the shift to inorganic potassium phosphates in the graphite SEI.

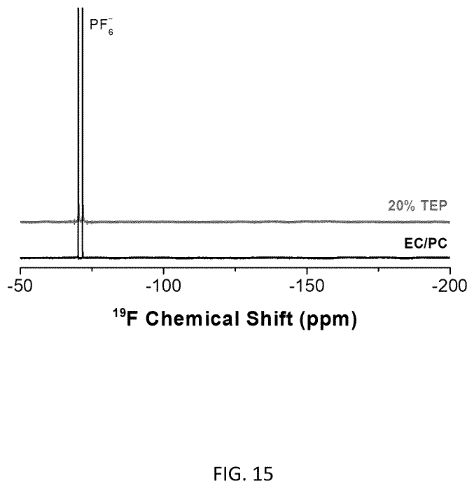

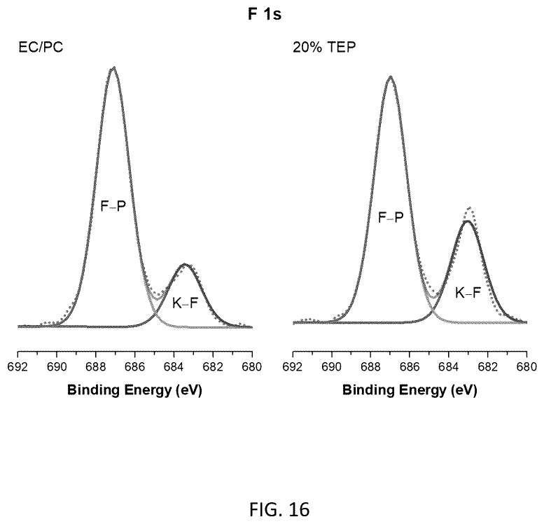

Improvements in capacity retention and charge-transfer are often correlated to increased quantities of inorganic phases in the SEI, such as metal fluorides. One can view KPF₆ as stable at low potentials, mitigating anionic decomposition. Indeed, 19F solution NMR of the dissolved graphite electrodes exhibit no peaks at the frequencies assigned to F—(−125 ppm) from dissolved KF (FIG. 15). Analysis of the F is orbital in XPS indicates that both electrolytes yield KF in the SEI (FIG. 16), suggesting that there is discrepancy between these two analytical techniques. In Li-based systems, beam damage in XPS has been repeatedly shown to artificially increase LiF content from Li salt exposure to X-rays, and we believe that the same phenomenon may be occurring in our experiments. Therefore, we cannot reliably attribute the improved capacity retention and reduced RCT to an increasingly fluorinated SEI—or at the very least, this suggests that there are alternative methods to achieving these performance outcomes. One can posit that the combination of carbonate and phosphate reduction products results in a passivating SEI.

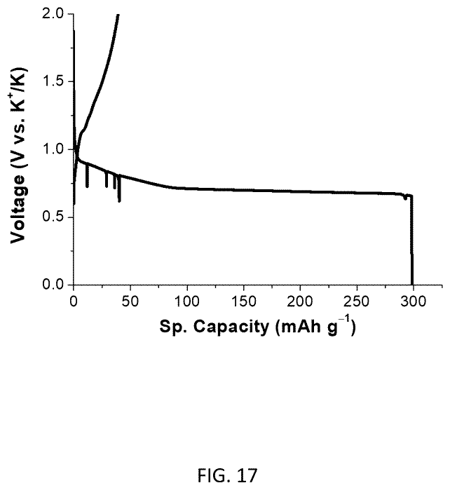

In summary, 1 M KPF₆ EC/PC with 20 vol % TEP serves as a compelling electrolyte in the carbonate/phosphate design space. It offers intrinsic nonflammability in both liquid and vapor phases, relatively high ionic conductivity compared to HCEs with TEP as the sole solvent, and compatibility with K-ion intercalation into graphite at low salt concentration. EC, PC, and TEP are all affordable and mass-produced. Moreover, the TEP cosolvent appears to reduce overpotential and improve capacity retention of graphite. The inorganic phosphate salts produced in the interphase, here characterized for the first time by NMR techniques, likely aid in passivation of the surface and prevent unmitigated carbonate reduction to soluble organic species. Prior to this report, low concentration TEP-based electrolytes have exhibited poorly passivating SEIs that lead to KIB performance degradation (e.g., FIG. 17 shows 1 M KPF₆ in TEP results in frequent shorts when used in half cell testing and almost no reversible capacity while 1 M KFSI in TEP has been shown to lose ˜40% capacity in 25 cycles). This provides a platform where one can construct a safe, low concentration electrolyte that is compatible with graphite in KIBs and through the use of routine optimization strategies (e.g., additives, formation protocols) maximize performance.

In addition, one may know that LiPF₆ readily reduces at the anode to form LiF that is embedded in the SEI. When using NMR spectroscopy, which does not reduce the KPF₆ salt, we see no evidence of KF in the SEI for either electrolyte formulation.

### Experimental Methods

Materials. Potassium hexafluorophosphate (KPF₆, >99.5%), lithium hexafluorophosphate (LiPF₆, >99.5%) ethylene carbonate (EC, anhydrous, 99%), propylene carbonate (PC, anhydrous, >99%), triethyl phosphate (TEP, >99.8%), diethyl carbonate (DEC, anhydrous, >99%), hexanes (anhydrous, >99%), sodium carboxymethyl cellulose (CMC), and 1 M LiPF₆ EC/DEC were purchased from Sigma Aldrich. KFSI (>99%) was purchased from Solvionic. Potassium metal (chunks in mineral oil, 98% trace metals basis) was purchased from ThermoFisher. 1 M KPF₆ EC/PC was purchased from LaborXing and used as received. Actilion GHDR 15-4 graphite was provided by Imerys Graphite & Carbon and used for hand-casting low-loading graphite films. For NMR experiments using high-loading electrodes, single-sided graphite-coated copper foil was purchased from MSE PRO.

TEP was dried over molecular sieves for 48 hours prior to adding to electrolyte. KPF₆ salt was dried in vacuo overnight at 100° C. EC/PC mixtures were stored with molecular sieves for at least 48 hours to remove residual water and achieve Karl Fischer titration readings <15 ppm H2O. EC/PC and TEP were filtered using a PTFE filter attached to a syringe to remove residue from the molecular sieves.

K metal was stored in the glovebox in mineral oil. Prior to use, the purification method developed by Dhir et al. was used. 1 The black oxide layer surrounding the K metal chunks was removed with a razor blade, and the cleaned pieces were then melted in a beaker on a hot plate in the glovebox. Solid impurities were skimmed off the surface until it was highly reflective and clean, then the molten K was poured directly into mineral oil and quenched.

Graphite Electrode Fabrication. Graphite electrode films were made by mixing a 9:1 mass ratio of graphite:CMC binder. First, water was added dropwise (˜10 drops per 100 mg of dry mixture) to the CMC in a mortar and pestle. The graphite was then hand mixed in until a uniform slurry was formed (˜10 minutes). The slurry was cast onto a Cu current collector (6 μm thick, MTI) using a 50 m doctor blade and dried at 100° C. under vacuum overnight. The dried film was punched into 12.7 mm diameter disks to use in cell assembly. Typical mass loadings of active material were 0.5 mg cm-2.

Electrolyte Formulations. To formulate “20% TEP” electrolyte, 20 vol % TEP was added to the 1 M KPF₆ EC/PC electrolyte purchased from LaborXing. To return the concentration to 1 M, additional KPF₆ was dissolved. The same procedure was done for 1 M LiPF₆ EC/DEC with 20 vol % TEP. 1 M LiPF₆ EC/PC, 1 M KPF₆ EC/DEC, and 2 M KFSI TEP were mixed by hand.

Flammability and Conductivity Tests. To test the self-extinguish time (SET) of electrolytes, 15 mm diameter glass fiber separators were saturated with 50 μL of electrolyte. The separator was attached to a ring stand in a closed fume hood, ignited with a butane lighter, and then recorded via video. Combustion time commenced from the moment a flame was observed above the separator. Tests were repeated three times and averaged. To test vapor flammability, a custom aluminum hot plate was machined with indentations for two vials. The hot plate temperature was controlled with a Creality heating element and thermistor. The vials were each filled with 1 mL of EC/DEC with 20 vol % TEP or EC/PC with 20 vol % TEP and covered with aluminum foil. 200° C. was chosen as the temperature because it is below the boiling point of both solutions but allows for significant vapor pressure to build. After equilibrating at 200° C. for 20 minutes, the aluminum foil was punctured and a butane flame was held above the two vials.

Ionic conductivity measurements were conducted at 24° C. on a Mettler SD30 conductivity meter equipped with InLab 751 probe. The meter was calibrated with standard 12.88 μS cm-1 solution. Measurements were recorded in triplicate and averaged.

Electrochemical Cycling and Characterization. All cell assembly took place in an Ar-filled glovebox (O2<0.1 ppm, H2O<0.5 ppm). To assemble K half cells, K metal was first rinsed thoroughly in hexanes to remove all mineral oil, then placed in a bag coated with hexanes and rolled into thin sheets (˜0.25 mm thick) using a cylindrical weight. The K sheet was then removed from the bag and, after waiting for the hexanes to evaporate, stamped into 12.7 mm diameter disks. Coin cells were saturated with 200 μL of electrolyte.

2032-type coin cell casings were used to assemble all cells. Separators were 15 mm diameter glass microfiber separators (purchased from GE Life Sciences); all cell components were dried at 60° C. overnight.

Galvanostatic cycling experiments were performed on an Arbin battery cycler with an initial C/20 SEI formation cycle, followed by 100 cycles at C/5 (where nC refers to full theoretical discharge in 1/n hours). C-rates were calculated from the theoretical capacity of graphite for the formation of KC8 (279 mAh g-1) or LiC6 (372 mAh g-1).

For EIS measurements, K∥Gr half cells were assembled and underwent formation at C/20. Cells were then discharged at C/20 to 0.1 V (approximately 50% SOC) and held at constant voltage for 2 hours. K∥Gr cells were then immediately disassembled in the glovebox and reassembled as Gr∥Gr symmetrical coin cells with a new separator and fresh electrolyte. EIS was performed on a Biologic SP-150 potentiostat with voltage perturbation of 10 mV, frequency range 1 MHz to 0.1 Hz, sampling 10 points per decade and averaging 5 measurements per point. Spectra were fit using EIS Spectrum Analyzer using the equivalent circuit shown in FIG. 3.

X-ray Diffraction. Prior to XRD, K∥Gr half cells underwent one C/20 discharge or one C/20 formation cycle followed by a C/5 discharge to 0 V. Cells were disassembled in an Ar-filled glovebox and the graphite electrodes were briefly rinsed in DMC before drying under vacuum in the glovebox antechamber for 30 minutes. The pristine graphite control was an uncycled electrode of the same loading. For data collection, electrodes were placed on a zero-background Si plate in the glovebox and sealed with Kapton polyimide film (Chemplex) in an air-free sample holder. XRD patterns were collected on a PANalytical XPERT3 powder diffractometer with Cu Kα radiation.

X-ray Photoelectron Spectroscopy and Raman Spectroscopy. K∥Gr half cells charged to 2 V were disassembled in an Ar-filled glovebox following 20 cycles at C/5. Pristine electrode samples were assembled in a coin cell with electrolyte but without K metal, then immediately disassembled. Before measurement all graphite electrodes were triple rinsed with 2 mL DMC and vacuum-dried in the glovebox antechamber overnight. Samples were transported using an air-free transfer chamber and characterized on a VersaProbe II XPS under the following conditions: monochromatic Al filament source (1486.7 eV) with 15 kV at 50 W, 45-degree source analyzer angle, pass energies of 117.4 eV (survey) and 23.5 eV (high resolution). Fitting was carried out with CasaXPS. For cycled samples, peaks were fit using a 70% Gaussian-30% Lorentzian Voigt peak shape, calibrated to the C-C peak at 285.0 eV, and constrained to have equal peak width within the same orbital (<2 eV). The pristine electrode samples were calibrated to the C═C peak at 284.0 eV, which followed an asymmetric Lorentzian peak shape and was constrained to narrow peak width (<1 eV). A Shirley baseline correction was applied to all data.

A section of the cycled electrodes used for XPS were cut out using a razor blade in an Ar-filled glovebox, then transported in air to a Renishaw inVia micro-Raman spectrometer. A laser excitation wavelength of 633 nm was used and calibrated with a Si wafer referenced to 520.5 cm-1. Samples were analyzed using a ×50 lens objective, laser power at 50% (3 mW), 2 s exposure time, and 10 accumulations. D and G peaks were numerically integrated using a linear baseline correction and identical peak bounds for all samples.

TABLE 1
Solvent properties.

| | | Dielectric | Donor |
|---|---|---|---|
| | Boiling Point (° C.) | Constant | Number |
| EC | 244 | 64.6 | 15.1 |
| PC | 242 | 90.8 | 16.4 |
| TEP | 215 | 13.1 | 23.4 |
| DEC | 126 | 2.8 | 16 |

Note on Compatibility of PC with graphite in LIBs and KIBs.

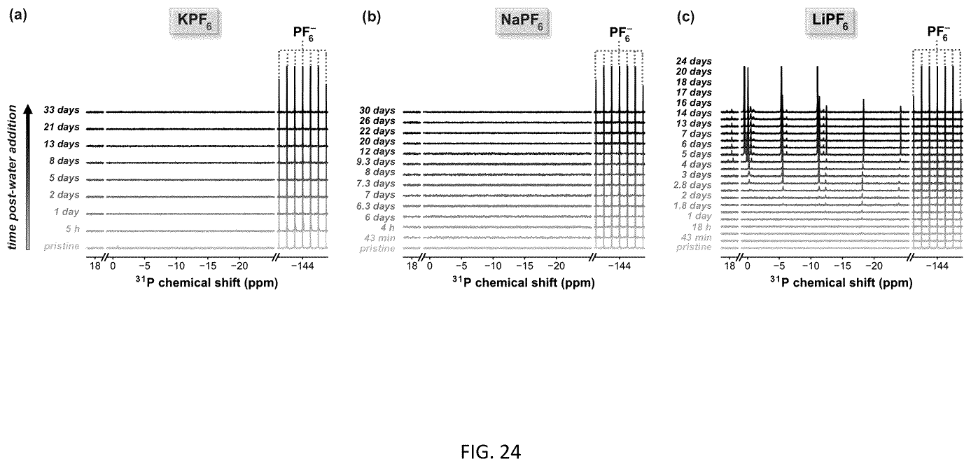

While solvent mixes containing PC have been largely abandoned for use in LIBs, PC has not shown the same detriment to graphite anodes in KIBs and continues to be used. FIG. 24 shows the voltage profile of the formation step in graphite half cells cycled opposite Li or K. In the Li cell, voltage remains high in the initial 100 mAh/g of the initial discharge, consistent with PC decomposition and co-intercalation. The K cell does not show the same elevated voltage. The compatibility of PC with K electrolytes may be due to the weaker coordination of K⁺ to PC compared to Li, due to weaker Lewis acidity. FIG. 7 shows ¹⁷O NMR spectra of “neat” EC/PC with 20 vol % TEP and electrolytes with 1 M LiPF₆ or KPF₆ added. Solvating Li⁺ results in an upfield shift of 6 ppm compared to 2 ppm for K⁺, indicating much stronger coordination. Stronger coordination increases susceptibility to reduction and co-intercalation.

TABLE 2
EIS fits.

| | | |
|---|---|---|
| Component | Value | Error |

EC/PC

| | | |
|---|---|---|
| R_{b} (Ohms) | 104 | 1% |
| R_{CT} (Ohms) | 6750 | 3% |
| CPE_{CT} (C (μF), n) | 25.9, 0.90 | 1%, 0.3% |
| W (Ohm s^{-1/2}) | 4460 | 5% |

20% TEP

| | | |
|---|---|---|
| R_{b} (Ohms) | 94 | 1% |
| R_{CT} (Ohms) | 4930 | 4% |
| CPE_{CT} (C (μF), n) | 28.4, 0.90 | 2%, 0.4% |
| W (Ohm s^{-1/2}) | 2900 | 7% |

TABLE 3
XPS assignments.

| | Pristine EC/PC | | Pristine 20% TEP | | Cycled EC/PC | | Cycled 20% TEP | |
|---|---|---|---|---|---|---|---|---|
| | Binding Energy (eV) | | Binding Energy (eV) | | Binding Energy (eV) | | Binding Energy (eV) | |
| Bond | [% in Orbital] | | [% in Orbital] | | [% in Orbital] | | [% in Orbital] | |
| C═C | 284.0 | [27%] | 284.0 | [30%] | N/A | | N/A | |
| C—C | 285.1 | [10%] | 285.0 | [10%] | 285.0 | [38%] | 285.0 | [45%] |
| C—O | 286.8 | [47%] | 286.6 | [45%] | 286.5 | [46%] | 286.5 | [33%] |
| C═O | 288.5 | [16%] | 288.1 | [15%] | 288.0 | [14%] | 288.1 | [16%] |
| O—C═O | N/A | | N/A | | 289.4 | [2%] | 289.4 | [6%] |
| O═P, | 531.7 | [27%] | 531.4 | [25%] | 531.1 | [46%] | 531.1 | [65%] |
| O═C | | | | | | | | |
| O—C | 533.3 | [69%] | 533.0 | [70%] | 532.9 | [52%] | 532.9 | [33%] |
| O—Fₓ | 536.0 | [4%] | 535.8 | [5%] | 535.2 | [2%] | 535.2 | [2%] |
| F—P | 687.4 | [100%] | 687.6 | [100%] | 687.1 | [81%] | 687.0 | [71%] |

| F—K | | | | 683.4 | [20%] | 683.1 | [29%] |
|---|---|---|---|---|---|---|---|
| P—F | | | | 136.9 | [30%] | 136.9 | [38%] |
| P—O | 134.0 | [100%] | N/A | 133.0 | [70%] | 133.3 | [62%] |

We note that P 2p spectra for pristine electrode samples have peaks assigned to P—O rather than P—F from residual KPF₆. We believe this is due to X-ray beam damage, 3 as P 2p was one of the final experiments.

### Additional Disclosure

The decomposition of LiPF₆ in non-aqueous battery electrolytes is a deleterious process that leads to hydrofluoric acid (HF)-driven transition metal dissolution at the positive electrode and gas production (H₂) at the anode that is attributed to the inherent moisture sensitivity of the hexafluorophosphate anion. In this disclosure, we use in situ nuclear magnetic resonance (NMR) spectroscopy to demonstrate that the rate of PF₆⁻ hydrolysis significantly decreases in Na and K systems, where the Lewis acidity of the cation dictates the rate of decomposition according to Li⁺>Na⁺>K⁺. Despite the remarkable stability of Na and K electrolytes, we show that they are still susceptible to hydrolysis in the presence of protons, which can catalyze the breakdown of PF₆⁻, indicating that these chemistries are not immune from decomposition when paired with solvent/cathode combinations that generate H⁺ at high voltage. Quantitative in situ multinuclear and multidimensional NMR of decomposed electrolytes shows that after long-term degradation, these systems contain HF, HPO₂F₂, and H₂PO₃F as well as a variety of defluorinated byproducts, such as organophosphates and phosphonates, that are structurally similar to herbicides/insecticides that may pose health and environmental risks. Taken together, these results have implications for Na- and K-ion batteries where hazardous and harmful byproducts like HF, soluble transition metals, organophosphates, and phosphonates, can be greatly reduced through cell design and also suggest that next generation chemistries present a pathway to safer batteries that contain lower quantities of flammable gases, like H₂, if properly engineered.

LiPF₆-based non-aqueous liquid electrolytes are the prevailing choice for Li-ion batteries (LIBs) in both commercial and academic settings. LiPF₆ was originally chosen for its high ionic disassociation, ionic conductivity, low cost and electrochemical anion decomposition to form a passivating layer on the surface of the Al current collector. However, the significant drawback to LiPF₆ is its proclivity to hydrolyze, even in battery-grade electrolytes controlled to <20 ppm water. Note that water is also a byproduct of ethylene carbonate (EC) oxidation and residual Li₂CO₃ decomposition at high voltage, so LiPF₆ will breakdown during cycling regardless. One of the major products of LiPF₆ hydrolysis is HF, which can etch transition metals from LIB cathodes and interact with the anode to form H₂ gas leading to cell degradation and safety concerns. In addition, LiPF₆ can be directly reduced at the anode to form resistive LiF and a variety of other salt decomposition products, such as LiₓPF_{y} and LiₓPO_{y}F_{z}, that may not passivate the electrode surface. Overall, these observations have led to the widespread belief that the PF₆⁻ anion is both hydrolytically and electrochemically unstable in non-aqueous battery electrolytes that contain small quantities of water.

In contrast to other observations, we observe little to no decomposition of KPF₆ to KF and other associated byproducts (e.g., HF) during electrochemical cycling of K-ion batteries (KIBs) with a positive correlation with performance. For example, we analyzed the solid electrolyte interphase (SEI) of hard carbon anodes in K half cells after cycling in 1 M KPF₆ in ethylene carbonate:propylene carbonate (EC:PC) with solid-state nuclear magnetic resonance (NMR) spectroscopy and X-ray photoelectron spectroscopy (XPS) and could not detect any KF with either method. We saw that these cells cycled stably, but upon addition of fluoroethylene carbonate (FEC), which preferentially reduces to form KF during cycling, there was an immediate drop in capacity. Likewise, it has been shown that when K metal is plated in 1 M KPF₆ in dimethoxyethane (DME), which exhibits very little KF via XPS, it displays extremely smooth ingot-like deposition (i.e., no K⁰ dendrites). These trends appear to hold for the bis(fluorosulfonyl)amide (FSA⁻) analogues across the monovalent alkali metal salts as well, where significantly less fluorinated components are detected in the SEI on hard carbon anodes in Na- and K-ion systems after cycling compared to Li. In addition to improved reductive stability upon swapping Li for Na or K, initial reports also suggest that the hydrolytic stability of PF₆⁻ may be improved in beyond Li systems. One can use ion chromatography (IC) to show that the rate of PF₆⁻ hydrolysis in aqueous solutions increases in the order of Li⁺>Na⁺>K⁺, with the latter two showing negligible amounts of hydrolysis after one week.

While it is well-known that HF presents a serious safety hazard in batteries, recent reports have also raised concerns over the human health risks associated with other organofluorophosphate derivatives that arise during cycling of LIBs. One finds that increasing the water content (from ˜50 ppm to 10,000 ppm) in 1 M LiPF₆ in carbonate solvents can shift the final product distribution, resulting in possible safety outcomes. Results from in situ NMR suggest that under low water conditions (10¹-10² ppm), the reaction terminates with end products HF and HPO₂F₂, where the main hazard is HF. As water content increases to the 10³-10⁴ ppm range, the reaction progresses to form H₂PO₃F and additional HF as major products, but then H₂PO₃F can undergo additional hydrolysis to form a variety of other compounds including phosphoric acid and organofluorophosphates for which the toxicity is not well understood. These differences in product quantification have been debated when analyzed via IC, which cannot easily distinguish between PO₂F₂⁻ and PO₃F²⁻ anions, often leading to the erroneous conclusion that PO₃F²⁻ does not form during LiPF₆⁻ hydrolysis. Furthermore, IC uses an aqueous mobile phase, which could compromise its accuracy in characterizing electrolyte hydrolysis. Overall, given the implications that PF₆⁻ breakdown has for battery degradation and safety, it is useful to (1) identify if there is a periodic trend in the rate of PF₆⁻ hydrolysis and (2) characterize the structure of the resulting PF₆⁻ decomposition products.

In this disclosure, we investigate the role of the counterion on the rate of PF₆⁻ hydrolysis in 1 M XPF₆ (X=Li, Na, K) in EC:PC containing 1.5 vol % water using in situ ¹⁹F and ³¹P NMR spectroscopy. We find that the rate of hydrolysis increases as the Lewis acidity of the cation increases (Li⁺>Na⁺>K⁺), with Li showing the fastest rate of hydrolysis over the course of approximately one month, while K shows no detectable hydrolysis products. Using two-dimensional (2D) ¹⁹F-³¹P, ³¹P-¹H, and ¹H-¹H correlation NMR experiments, we perform a structural assignment of the hydrolysis products that form upon LiPF₆ breakdown (including a number of hazardous species) and confirm that these are generated under realistic battery operating conditions (200 ppm water), albeit in different quantities. To test the hypothesis that the rate of breakdown of XPF₆ increases with the Lewis acidity of the cation, we show that rapid (timescale on the order of min) hydrolysis can be induced in Na and K electrolytes upon addition of HCl (where H⁺ is a strong Lewis acid). These results have downstream effects for the safety and selection of battery materials and battery operation conditions as well as routine performance testing in beyond Li-ion systems.

### Results

Role of alkali cation identity on XPF₆ hydrolysis (X=Li, Na, K)

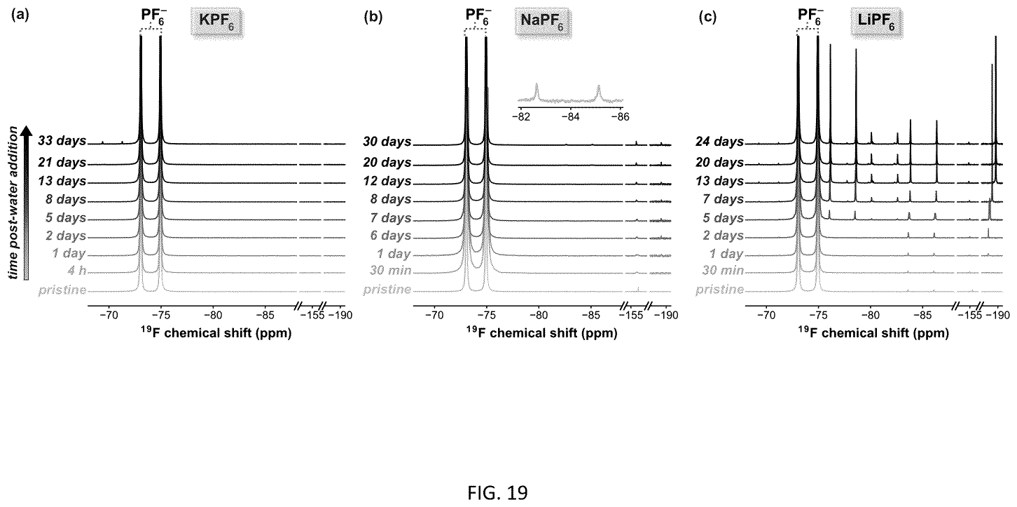

To understand how changing the alkali metal cation paired with hexafluorophosphate anion impacts the rate of hydrolysis, we begin by adding 1.5 vol % (˜11000 ppm) of fresh, nanopure H₂O to solutions of 1 M LiPF₆, NaPF₆, and KPF₆ in EC:PC and monitoring the ¹⁹F NMR spectra in situ over the course of about one month (FIG. 19). Prior to water addition (FIG. 19, pristine), all three spectra show a high intensity doublet at δ_{F}=−74.0 ppm (¹J_{P-F}=709 Hz) that is assigned to PF₆⁻. A corresponding high intensity septet also appears in the ³¹P NMR region corresponding to hexa-coordinated phosphorus (δ_{P}=−144.0 ppm, ¹J_{F-P}=709 Hz, FIG. 24) in all the initial samples. After the addition of water, we see clear differences in the extent of PF₆⁻hydrolysis for electrolytes prepared with different counter-cations based on the appearance of new resonances (or lack thereof) in ¹⁹F NMR as a function of time.

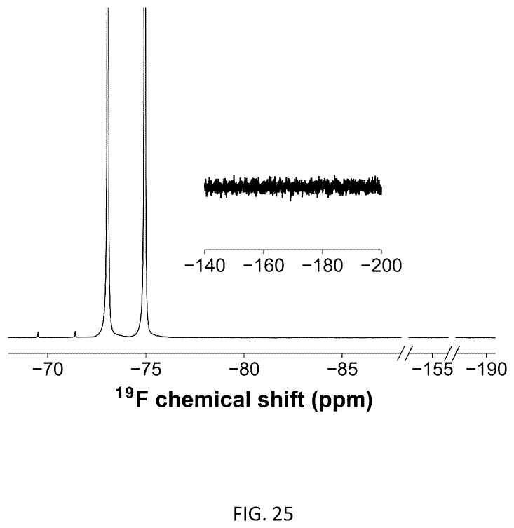

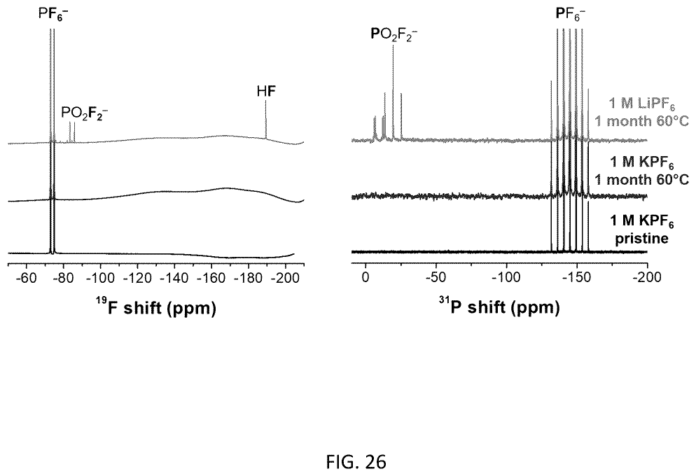

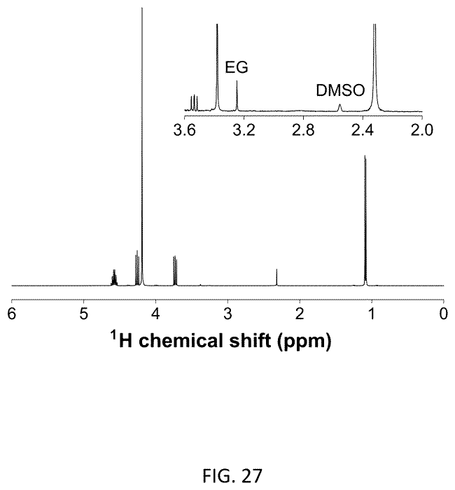

The initial ¹⁹F NMR spectra collected both pre- and immediately post-water addition in the KPF₆ electrolyte show that the only species present is PF₆⁻, suggesting that KPF₆ electrolytes are not susceptible to hydrolysis (FIG. 19a). Periodic analysis of the sample over the course of 33 days also shows no evidence of hydrolytic decomposition. PF₆⁻ continues to show remarkable stability in K-based electrolytes four and a half months after water addition (FIG. 25). In fact, even after heating 1 M KPF₆ in EC:PC at 60° C. for one month, we observe no changes in ¹⁹F or ³¹P NMR (FIG. 26). After water exposure for 33 days, the only new ¹⁹F NMR signal that emerges is a small doublet at δ_{F}=−70.2 ppm (J_{P-F}=711 Hz) that we assign to a new PF₆⁻ species with a distinct coordination environment from that of the original salt (δ_{F}=−74.0 ppm (¹J_{P-F}=709 Hz)). It has been seen that changing the counter-cation and/or the local solvation environment about the anion can lead to similarly minor changes in ¹⁹F shift and P-F J-coupling; even smaller shift changes are observed in ³¹P NMR (we perform a more in-depth assignment for this resonance later). Examination of the corresponding ¹H NMR spectrum also collected at 33 days indicates that instead of the salt, water interacts with EC to form ethylene glycol (EG), as indicated by the singlet at 3.3 ppm (FIG. 27). These data suggest that solvent decomposition occurs instead of the salt, and that the resulting decomposition products likely alter the local environment of some of the PF₆⁻ anions.

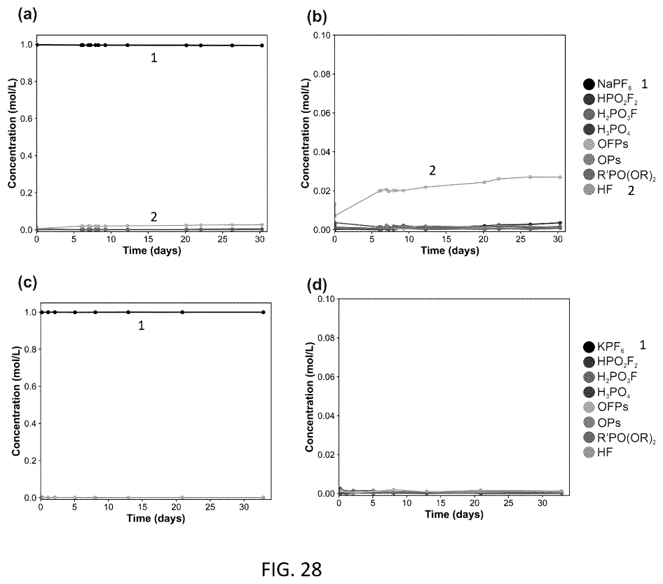

In the NaPF₆ electrolyte, we observe an intermediate amount of PF₆⁻ hydrolysis, where the system appears to be more reactive than K, but clearly less reactive than Li (FIG. 19b and FIG. 28). In the ¹⁹F NMR spectrum of the pristine NaPF₆ electrolyte with no exogenous water, we see a small doublet at δ_{F}=−83.9 ppm (¹J_{P-F}=941 Hz, FIG. 19b inset), assigned to PO₂F₂⁻. In addition, we also see a resonance for F⁻ (δ_{F}=−156 ppm (s)), which likely arises due to dissociation of HF in solution. The presence of PO₂F₂⁻ and F⁻ in the as-prepared electrolyte suggests that (i) moisture has caused the salt to hydrolyze on the shelf prior to dissolution and/or (ii) residual water in the solvent leads to NaPF₆ hydrolysis in the time that it takes to transport the sample from the glovebox to the NMR facility and run the experiment (<30 min).

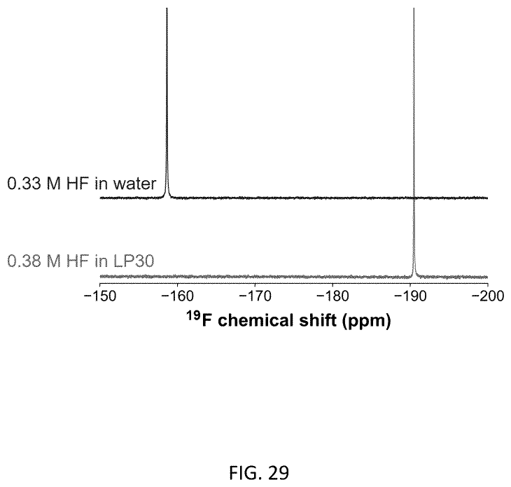

Once 1.5 vol % H₂O is added to the NaPF₆ electrolyte, the shift for F⁻ at δ_{F}=−156 ppm begins to broaden (FIG. 19b, 30 min). After one day, a broad doublet emerges, which is consistent with hydrogen-bonded HF coordination complexes. Six days into the experiment, an additional singlet appears at δ_{F}=−189 ppm and the original peak at δ_{F}=−156 ppm has returned to a singlet. The ¹⁹F chemical shift for HF covers this entire region and is extremely sensitive to local coordination environment (see Supporting Information (SI) for control experiments where we directly add HF acid to different solvents, FIG. 29), exhibiting multiple different splitting patterns depending on concentration and temperature. After 30 days, 0.6 mol % of ¹⁹F NMR signal is assigned to both HPO₂F₂ and HF (FIG. 19b, dark brown), but no new compounds are observed under these experimental parameters, indicating that while hydrolysis of NaPF₆ does occur, it is slower and more limited than that observed for LiPF₆. Scheme 1 shows the proposed reaction mechanism for the hydrolysis of PF₆⁻ over the course of 30 days in the presence of Na⁺ and 1.5 vol % H₂O, where the principal hydrolysis products are HPO₂F₂ and HF. Note that this Scheme is analogous to what has been proposed for the breakdown of LiPF₆ in non-aqueous electrolytes that contain trace water.

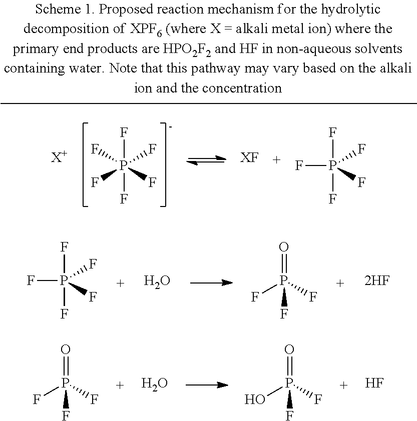

### Assignment of LiPF₆ Hydrolysis and Electrolyte Decomposition Products

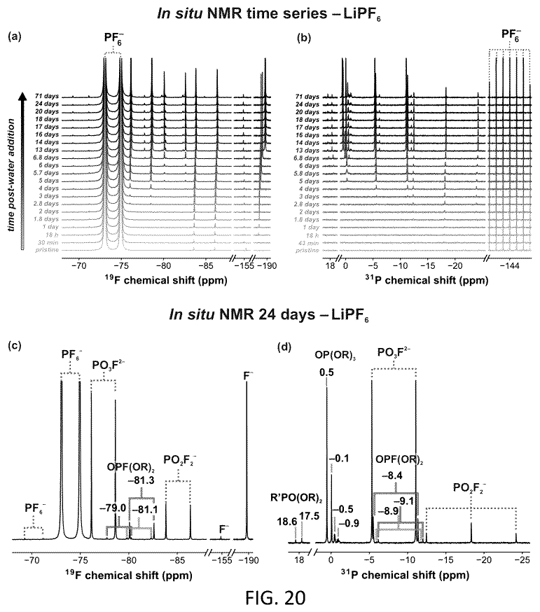

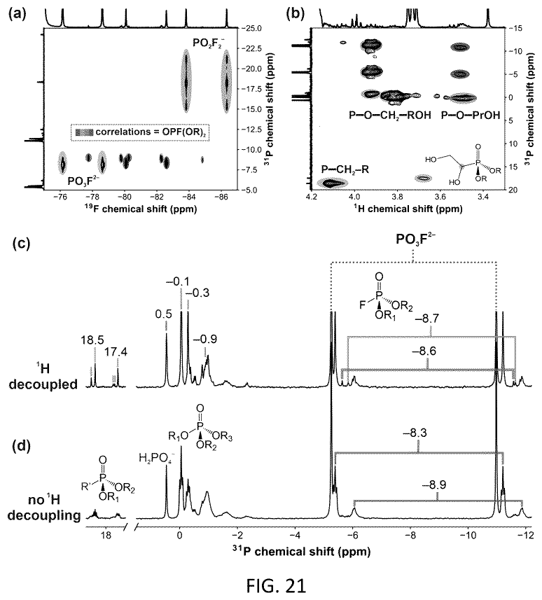

In the pristine LiPF₆ electrolyte, both ¹⁹F and ³¹P NMR spectra show resonances that correspond to PF₆⁻ as well as PO₂F₂⁻ and F⁻, as expected for systems that contain trace water (FIGS. 1c, 24c, and Scheme 1). As soon as we add 1.5 vol % H₂O, these peaks grow in intensity and throughout the 24 day-long experiment, a plethora of other decomposition products appear (a complete list of assignments can be found in Table 1). In the final scan, the signal for PO₂F₂⁻ has grown roughly six-fold, representing 2 mol % of the total decomposition products, indicating that LiPF₆ experiences significantly more decomposition than the Na and K analogues. In the following Sections, we describe how the PF₆⁻ breakdown products observed in NMR spectroscopy arise and evolve over time. We are guided by in situ time series data from ¹⁹F NMR, ¹H-decoupled ³¹P NMR, ¹H-coupled ³¹P NMR and 2D correlation NMR spectroscopy, where we utilize the 24-day long experiment (FIG. 19c and FIG. 20) as well as spectra collected 71 and 276 days after water exposure (FIG. 21) where the intensity of the final decomposition products has increased, making them more suitable structural assignment with 2D NMR.

### Initial Decomposition of Fluorophosphate Species in 1 M LiPF₆ Electrolyte

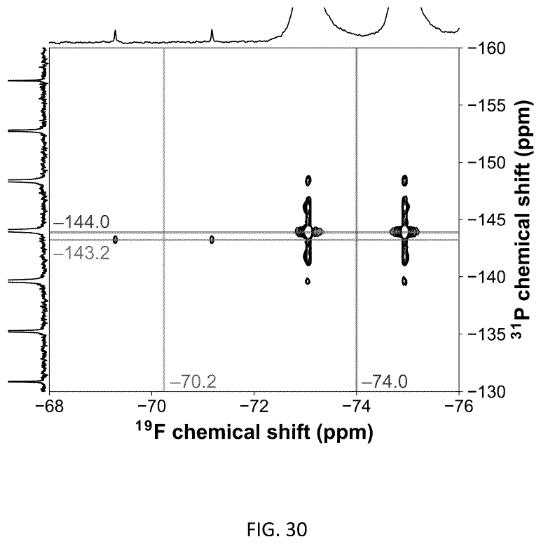

After the LiPF₆ electrolyte was exposed to 1.5 vol % H₂O for one day (FIG. 19c and FIG. 20), we see that the local coordination environment about the F anion has changed (moving from δ_{F}=−155 ppm to δ_{F}=−186 ppm (s)) and the signal intensity for PO₂F₂⁻ increased, indicating that more hydrolysis has occurred. At the same time, we also start to see a doublet in the ¹⁹F NMR spectrum at δ_{F}=−70.2 ppm (¹J_{P-F}=711 Hz) that we assign to another hexa-coordinated phosphorus species similar to PF₆⁻ that has a different local coordination environment, akin to what was observed after 33 days in the K electrolyte (FIG. 19a). This assignment is made on the basis of findings that the shift range and J-coupling values for PF₆⁻ ranged from δ_{F}=−70.3 to −71.7 and ¹J_{P-F}=708 to 711 Hz when switching the solvent from water to acetonitrile and using different counter-cations (e.g., K⁺, NH₄⁺). In addition, analysis of the LiPF₆ electrolyte after aging with water for 71 days with 2D ¹⁹F-³¹P heteronuclear multiple quantum coherence (HMQC) spectroscopy is also consistent with hexa-coordinated ³¹P, which shows a cross-peak between δ_{F}=−70.2 ppm and δ_{P}=−143.2 ppm; the most intense PF₆⁻ cross peak appears at δ_{F}=−74.0 ppm and δ_{P}=−144.0 ppm (FIG. 30). We believe that this peak may emerge due to changes in concentration of other ions (e.g., H+) or components in solution that arise during LiPF₆ hydrolysis.

### Formation and Assignment of Orthophosphate, Organofluorophosphates, and Organophosphates

Due to the increased rate and extent of hydrolysis in the LiPF₆ electrolyte, NMR scans were taken more frequently than what is shown in FIG. 19c and the complete set of spectra along with peak assignments is shown in FIG. 20. Three days after addition of H₂O, a doublet in ¹⁹F NMR at δ_{F}=−77.4 ppm (d, ¹J_{P-F}=928 Hz) and a corresponding doublet in ³¹P at δ_{P}=−8.2 ppm, (d, ¹J_{P-F}=928 Hz) appears for a new species, PO₃F²⁻ (FIG. 20), perhaps indicative of further hydrolysis of PO₂F₂⁻ according to the reaction shown in Scheme 2. At four days, complete defluorination of the initial hexafluorophosphate salt occurs, supported by the presence of a singlet in ³¹P NMR at δ_{P}=−0.5 ppm (FIG. 20), which is characteristic of non-halogenated phosphates. Simultaneously, we see a mono-fluorinated organophosphate product produced from interactions between solvent breakdown products and hydrolyzed salt species based on assignment from the doublet in ¹⁹F NMR at δ_{F}=−81.1 ppm (d, ¹J_{P-F}=943 Hz) as well as 2D ³¹P-¹H correlation spectroscopy below (FIG. 3b). The remaining organofluorophosphates have formed after 13 days, with shifts at δ_{F}=−79.0 ppm (d, ¹J_{P-F}=943 Hz) and δ_{F}=−81.3 ppm (d, ¹J_{P-F}=944 Hz) (FIG. 20), also consistent with mono-fluorinated organophosphates. Corresponding resonances are observed in ³¹P NMR (Table 1). After 13 days, we also see the formation of various resonances in the phosphate region of ³¹P NMR (δ_{P}=0.5 ppm (s), δ_{P}=−0.1 ppm (s), δ_{P}=−0.9 ppm (m)) and two singlets in the phosphonate region at δ_{P}=18.6 ppm (s) and δ_{P}=17.5 ppm (s) (FIG. 20). Comparison of the ¹H decoupled ³¹P NMR spectrum to an experiment with no ¹H decoupling at 276 days indicates that the singlet at 0.5 ppm corresponds to orthophosphate (i.e., H₃PO₄) while the others exhibit J-coupling values consistent with functionalized phosphates species (FIG. 3c, d and Table 1). If we refer back to the ¹⁹F NMR spectra in FIG. 19c, we note that the HF peak initially at δ_{F}=−186 ppm has grown significantly and gradually shifted up to −189 ppm over this same time period.

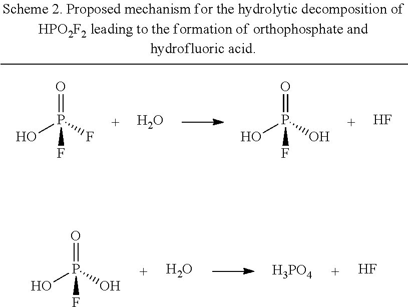

To better understand the various organic substituents that have formed during hydrolysis, we performed a series of 2D correlation experiments at 71 days (¹⁹F-³¹P HMQC, ³¹P-¹H HMQC, and ¹H-¹H correlation spectroscopy (COSY)). In the ¹⁹F-³¹P HMQC data (FIG. 3a), we see two cross peaks for species that have already been definitively assigned: (i) the ¹⁹F shift at δ_{F}=−85.1 ppm (d) and the ³¹P peak at δ_{P}=−18.3 ppm (t) that correspond to PO₂F₂⁻ and (ii) the cross peak for the ¹⁹F shift at δ_{F}=−77.4 ppm (d) and ³¹P at δ_{P}=−8.1 ppm (d) that represents PO₃F²⁻ (both represented by gray shading in FIG. 3a). With the assistance of ³¹P-¹H HMQC, the remaining four minor components are assigned to distinct organofluorophosphates OPF(OR)₂ (see Table 1 for indexing of individual shifts).

TABLE 1
List of NMR shifts and J-couplings associated with the compounds
identified in the L [symbol] electrolyte used in this work.
Note that these shifts change slightly in Na and K electrolyte
as noted in the text. Reported shifts are for NMR scans
71 days after initial water exposure; many shifts appear
at earlier time points as discussed in text.

| Chemical species | [symbol] F NMR | [symbol] P NMR | [symbol] H NMR |
|---|---|---|---|
| [symbol] | [symbol] | [symbol] | |
| (coordination 1) | Hz) | 709 Hz) | |
| [symbol] | [symbol] | [symbol] | |
| (coordination 2) | Hz) | 711 Hz) | |
| [symbol] | [symbol] | [symbol] | |
| | Hz) | Hz) | |
| [symbol] | [symbol] | [symbol] | |
| | Hz) | | |
| [symbol] | [symbol] | [symbol] | 3.9 ppm (overlap) |
| [symbol] | Hz) | | |
| green | | | |
| [symbol] | [symbol] | [symbol] | 3.9 ppm (overlap) |
| [symbol] | Hz) | | |
| purple | | | |
| [symbol] | [symbol] | [symbol] | [symbol] |
| alcohol, H), red | Hz) | [symbol] | [symbol] |
| [symbol] | [symbol] | [symbol] | |
| H), blue | Hz) | | |
| [symbol] | | 0.6 ppm ( [symbol] ) | |
| [symbol] | | [symbol] | [symbol] |
| alcohol, H) | | | [symbol] |
| [symbol] | | [symbol] | ~3.8 ppm |
| [symbol] | | | |
| [symbol] | | [symbol] | ~3.9 ppm (overlap) |
| | | [symbol] | |
| [symbol] | | [symbol] | 4.1 (broad, overlap) |
| [symbol] | | [symbol] | |

[symbol]

indicates data missing or illegible when filed

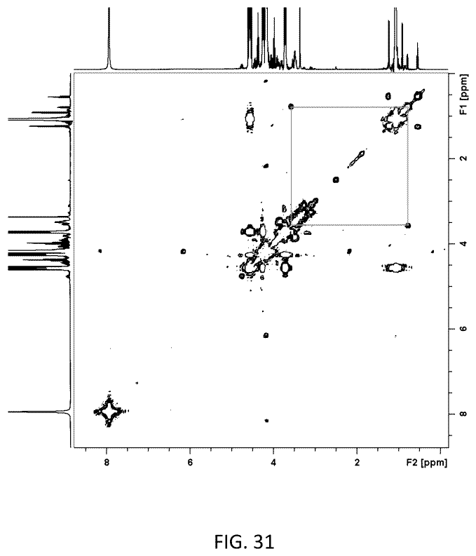

Closer inspection of the ³¹P-¹H HMQC along with ¹H-coupled ³¹P and ¹H-¹H COSY data sheds some light on the possible functional groups appended to the fluorophosphates (FIGS. 3b, 3c, 3d, and 31). For example, the compound that gives rise to the cross peak in ¹⁹F at δ_{F}=−81.3 ppm and ³¹P at δ_{P}=−8.4 ppm (both doublets, ¹J_{P-F}=944 Hz, FIG. 3a, red) also shows a cross peak with the multiplet in ¹H at δ_{H}=3.5 ppm in ³¹P-¹H HMQC (FIG. 3b, red). ¹H-¹H COSY reveals that this complex environment is bonded to a doublet at δ_{H}=0.8 ppm (d, ¹J_{H-H}=6.5 Hz), which is consistent with R=propyl alcohol on OPF(OR)₂ (FIG. 31). This compound also appears as a triplet in ¹H-coupled ³¹P NMR with ³J_{P-H}=8.4 Hz, indicative of a —POCH₂— group (FIG. 3d). On the other hand, the degradation product with a cross peak in ¹⁹F-³¹P HMQC at δ_{F}=−79.0 ppm and δ_{P}=−9.1 ppm (¹J_{F-P}=943 Hz, FIG. 3, purple) has no cross peak at similarly low frequencies in ¹H-¹H COSY that would suggest this fragment is terminated in a methyl group; instead, we find a cross peak between the ³¹P resonance and protons near 3.9 ppm in the ³¹P-¹H HMQC, indicating this moiety likely has an —OH terminal arm. In addition, we believe that the breakdown product highlighted in green in FIG. 3 is also an —OH-terminated organofluorophosphate, given that it exhibits a cross peak at δ_{F}=−81.1 ppm and ³¹P at δ_{P}=−8.9 ppm (both doublets, ¹J_{P-F}=943 Hz) and shows similar J-coupling to the other species. The corresponding ¹H correlation near 3.9 ppm in ³¹P-¹H HMQC is also consistent with this chemistry. Finally, we see that the cross peak in ¹⁹F-³¹P HMQC at δ_{F}=−83.6 ppm and δ_{P}=−8.7 ppm exhibits a distinct J-coupling, ¹J_{P-F}=962 Hz (FIG. 3, blue), consistent with organofluorophosphates of the form OPF(OR)₂, where R=methyl (Me), ethyl (Et), and the like. Given the example solvent system of EC:PC, one can tentatively assign these species to R=Et, propyl (Pr) (Table 1) where they likely overlap with solvent resonances and other decomposition products in ¹H NMR, but unfortunately this signal is too weak to observe. ³¹P-¹H HMQC and ¹H-coupled ³¹P NMR indicates that the fully defluorinated decomposition products with the chemical formula OP(OR)₃ exhibit similar R functional groups when compared to the organofluorophosphates (Table 1).

### Observation of Phosphonates and Additional Solvent Decomposition Products

After 6 days, ³¹P NMR displays two singlets at 18.6 and 17.5 ppm, which suggests that we have phosphonates in solution (e.g., R′PO(OR)₂, FIGS. 1c and 2). In ³¹P-¹H HMQC, cross peaks between δ_{P}=18.6 ppm (t, ²J_{P-H}=10.9 Hz) and δ_{H}=4.1 ppm (overlapping signals) as well as δ_{P}=17.5 ppm (dt, ²J_{P-H}=15.4 Hz, ³J_{P-H}=5.7 Hz) and δ_{H}=3.7 ppm (overlapping signals) support the formation of these species (FIG. 21b, orange). The ³¹P-¹H J-coupling information available in ¹H coupled ³¹P NMR indicates that the resonance at 17.5 ppm likely has a direct C—P bond from reaction between a solvent hydrolysis product, like EG and PF₆⁻ decomposition products (e.g., R═HOCHCH₂OH, FIG. 21b, d). Examination of the ¹H-¹H COSY for assignment of the organic substituents revealed other solvent breakdown products not appended to the hexafluorophosphate derivatives with terminal CH₃CH₂-groups (¹H-¹H cross peak at 0.6 ppm and 1.2 ppm) and vinylene carbonate (VC, singlet at 7.8 ppm, FIG. 31).

### Lack of Phosphorus-Containing Polymers

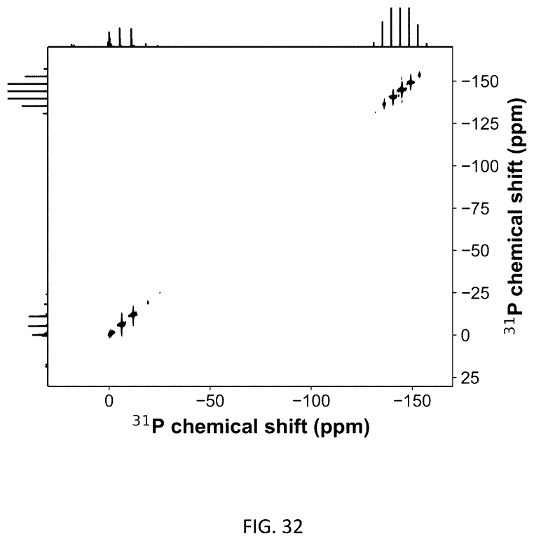

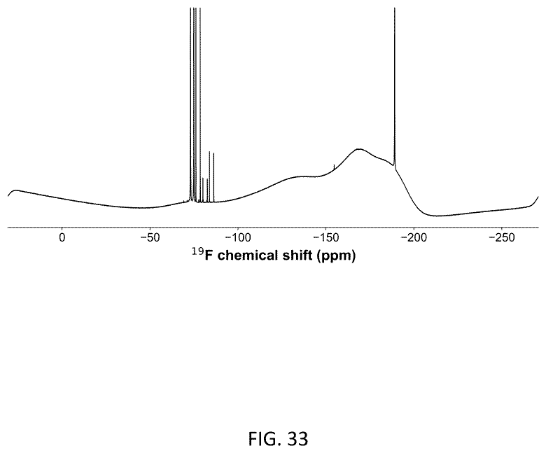

Although others suggest that fluorine capped phosphate oligomers and polyphosphates form under certain hydrolytic degradation scenarios, 2D ³¹P-³¹P COSY experiments (that test for P—O—P linkages) and a thorough sweep of our ¹⁹F spectral window (by moving our irradiation frequency) do not show evidence of these species in our sample, even at 71 days (FIGS. 32 and 33). Therefore, we believe that all the observed peaks belong to the broad classes of organofluorophosphates and organophosphates, with a small fraction of higher frequency components in ³¹P NMR that belong to phosphonate derivatives.

### Mechanism of Hydrolytic Breakdown and Subsequent Reactions in 1 M LiPF₆ Electrolyte

Based on our data, it is clear that under these reaction conditions (exposure to 1.5 vol % water at room temperature for approximately one month), 1 M LiPF₆ in carbonate solvent decomposes to form a variety of products including fluorophosphates, organophosphates, orthophosphate, and phosphonates, whereas K shows no detectable hydrolysis products and Na hydrolysis appears to form only limited quantities of HF. In Scheme 2, we show how HPO₂F₂, one of the main products of hydrolysis, can continue to undergo hydrolytic decomposition when exposed to water in the Li system, continuously forming HF in each step and eventually producing H₃PO₄. This pathway is consistent with our ¹⁹F and ³¹P NMR that show increasing amounts of HF as well as the emergence of H₂PO₃F.

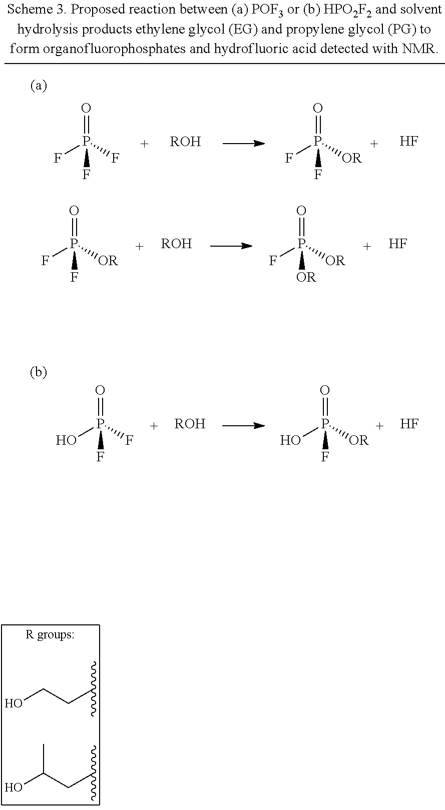

Scheme 3 proposes a pathway for the formation of organofluorophosphates via the reaction of fluorophosphates and solvent breakdown products, such as EG and propylene glycol (PG), that may arise from solvent hydrolysis in all of the electrolytes (see Scheme 4), but only interact with the salt when Li is present. Even though these species appear around the same time that we see complete defluorination of the hexafluorophosphate, we believe that the precursor for organofluorophosphate is a fluorophosphate, in part due to

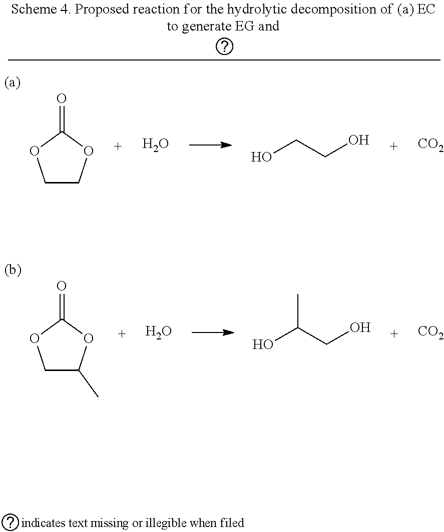

the fluoride ion being a better leaving group than hydroxide. Although this reaction can, in principle, take place with many fluorophosphate precursors, we depict it with POF₃ and HPO₂F₂. Upon integration of the ¹⁹F NMR signal intensities from the Li experiment, we see that HPO₂F₂ concentration drops when organofluorophosphates begin to form; POF₃ is a highly reactive gas, which may not be captured in our experiment. From Scheme 3, we see that reaction with POF₃ can account for the formation of OR-substituted components detected in NMR (e.g., OPF(OR)₂), whereas HPO₂F₂ produces mixed OR- and hydroxy-bound species (e.g., (e.g., OPF(OR)(OH)). With monofluorophosphates in hand, it is relatively straightforward to form completely defluorinated organophosphates and the reaction is similar to that of organofluorophosphates (Scheme 5). At this point in the reaction, there is a wide variety of possible reactants (at least four unique monofluorinated organophosphates are detected in solution) and R groups (three possible examples are shown in Scheme 5).

It is not immediately clear how the phosphonates that we observe at high frequency in ³¹P NMR are generated from the phosphates in the Li electrolyte. In principle, it may involve breakdown of the existing P(V) phosphates into P(III)-containing compounds that react with alkyl halides to form phosphonates via an Arbuzov-type mechanism.

### Quantification of Electrolyte Decomposition Products and Reaction Kinetics

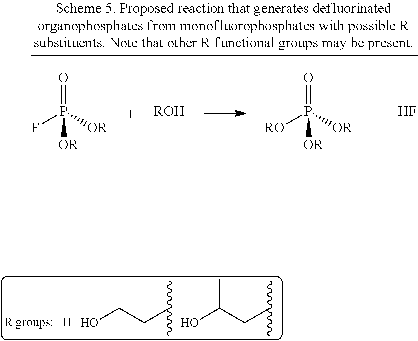

After 24 days of aging with water, we find that 0.4 M of the initial 1 M LiPF₆ has reacted. The main byproduct of PF₆⁻ decomposition is HF (detected as F⁻), with a final concentration of 1.2 M, which represents 75 mol % of the detected salt decomposition products. HPO₂F₂ and H₂PO₃F represent 2 mol % and 11 mol % of the total product distribution, respectively, while the organofluorophosphates, organophosphates, H₃PO₄, and phosphonates comprise 4 mol %, 5 mol %, 3 mol %, and <1 mol % of the total decomposition products.

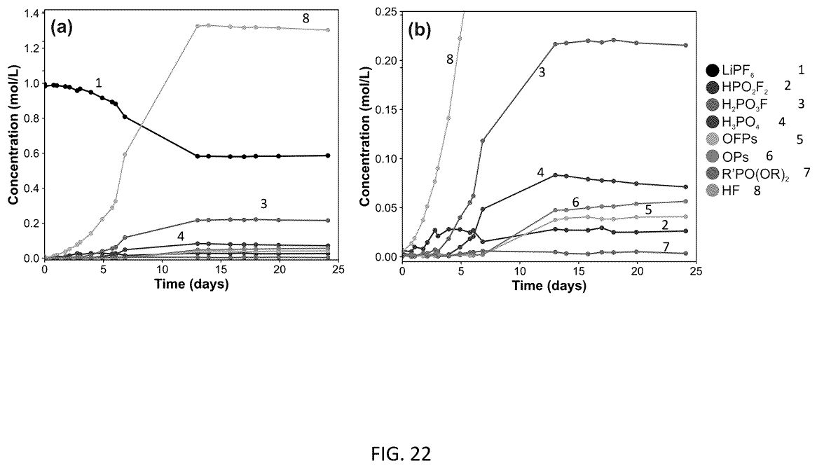

FIG. 22 depicts time series concentration data for integrated ¹⁹F and ³¹P NMR for each decomposition product. Most of the compounds exhibit logistic consumption/formation profiles, which are consistent with a self-catalyzed or “autocatalytic” reaction mechanism. Although some LiPF₆ hydrolysis reports have failed to identify these characteristic curves, one may suggest that the hydrolysis of fluorophosphates is acid-catalyzed (and hence autocatalytic). The proposed rate laws that come out of acid-catalysis for these reactants—albeit conducted in aqueous media—are of the form:

$$- \frac{d [ {PF}_{6}^{-} ]}{dt} = {k}_{1} [ {PF}_{6}^{-} ] [ {H}^{+} ] \qquad ( 1 )$$

To interpret this rate law, it is useful to approximate proton activity [H⁺] as HF concentration itself. HF is the predominant acid in solution and is likely fully dissociated since the peak at δ_{F}=−189 ppm appears as a singlet (rather than a doublet, which is observed for other HF coordination complexes at this peak positionClick or tap here to enter text). Furthermore, the dielectric constants for our cyclic carbonates are similar to that of aqueous solution. At the outset of the experiment, [PF₆—]>>[H+], however [HF] quickly increases, and although [PF₆—] falls in turn, the product of [PF₆—][HF] (and hence the reaction rate) increase initially. After a turning point, [PF₆⁻ ] becomes much smaller and the overall rate begins to decrease again despite continued [HF] growth—we observe a logistic curve.

In acid-catalyzed PF₆⁻ hydrolysis, fluorine-phosphorus bond cleavage is the centerpiece of the catalytic mechanism that first expedites the slow step of alkali metal hexafluorophosphate dissociation into metal fluoride and PF₅(Scheme 6a). Scheme 6b provides a proton-stabilized reaction intermediate that accelerates the decomposition of PF₆⁻ into HF and PF₅. After this point, PF₅ can readily react with H₂O according to Scheme 1 to form the subsequent hydrolysis products. Although we only show the interaction between H⁺ and PF₆⁻ in Scheme 6, protons in the electrolyte generated from the continuous production of HF can also interact with other fluorophosphate species to facilitate P—F bond cleavage and produce other byproducts.

The acid-catalyzed decomposition of PF₆⁻ may further explain the differences in reactivity between the Li-, Na-, and K-based electrolytes shown in FIG. 19. Li⁺ is a stronger Lewis acid compared to Na⁺ and K⁺ (Li⁺>Na⁺>K⁺), suggesting that it may

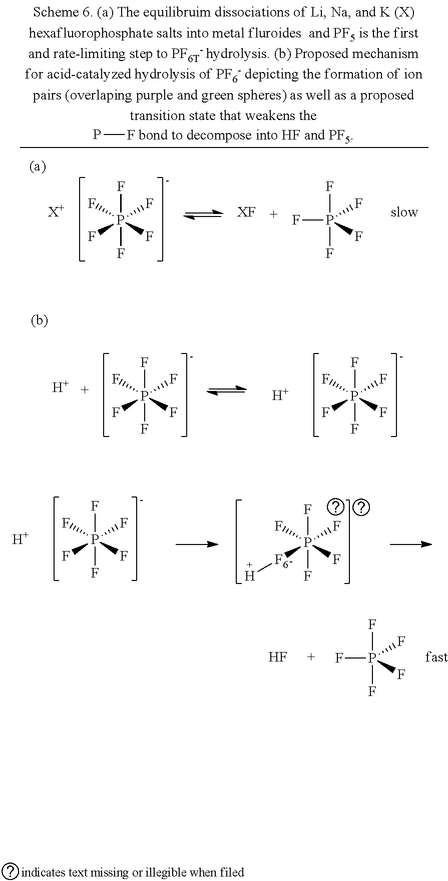

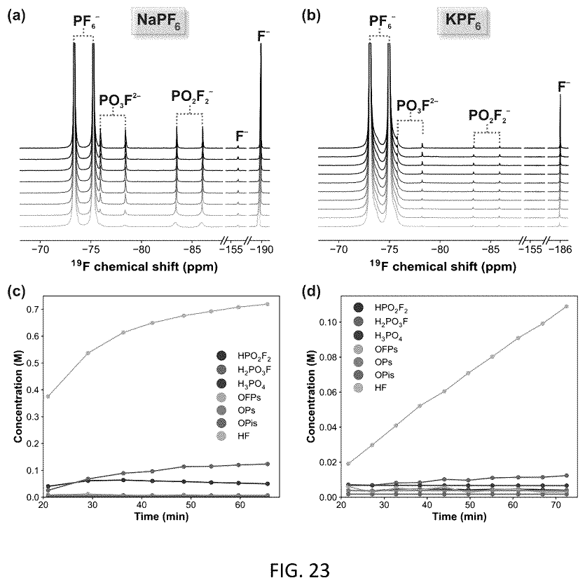

also polarize the P—F bond in a similar manner to H⁺ as shown in Scheme 6b and increase the rate of decomposition relative to the other alkali metals. To test this hypothesis, we simply added 1.5 vol % of 37% HCl to the 1 M NaPF₆ and KPF₆ electrolyte in EC:PC formulations and monitored the rate of hydrolysis via ¹⁹F NMR (FIG. 23).

The change in HF concentration as a function of time shown in FIG. 23 suggests an autocatalytic rate law similar to eq. 1, but with an additional factor to account for water as a limiting reactant:

$$- \frac{d [ {PF}_{6}^{-} ]}{dt} = {k}_{1} [ {PF}_{6}^{-} ] [ {H}^{+} ] [ {H}_{2} O ] \qquad ( 2 )$$

In the initial rate law introduced above (eq. 1), we assumed that [H+]≈[HF] to explain why we observe logistic curves. With the addition of HCl, we can see that this trend no longer holds since the addition of HCl overwhelms the contribution of [HF] to [H+]. Rather, we introduce a new approximation, where [H⁺]≈[HCl], which allows us to rationalize the lack of a logistic curve. We can explain the lack of initial acceleration for decomposition because the reaction is already at “full speed” from the added HCl (which is not consumed in the reaction), and can only slowdown from eventual reactant depletion, as shown in FIG. 23c for the NaPF₆ electrolyte. In the KPF₆ electrolyte, we do not see a decrease in rate in the observed timeframe because not enough decomposition has occurred, a consequence of the relative hydrolytic stability of K⁺>Na⁺ which is mathematically accounted for in the rate constant. In this timeframe under little reactant depletion, [PF₆⁻ ] and [H₂O] have stayed roughly constant, thus we expect a linear concentration profile arising from a constant reaction rate, which is exactly what is observed in FIG. 23d. These data allow us to reiterate the observation of this report: the relative acidity of the counter-cations in solution can dictate the rate of PF₆⁻ breakdown in carbonate solvent, even Na and K electrolytes.

### Discussion

The NMR data presented in this work demonstrates that the rate of PF₆⁻ hydrolysis depends on the Lewis acidity of the counter-cation. More acidic cations (H⁺>Li⁺>Na⁺>K⁺) weaken P—F bonds (Scheme 6) and accelerate decomposition of PF₆. This is particularly insidious with H⁺ because once this process is set in place, PF₅ readily reacts with surrounding water molecules, allowing H⁺ to interact with other P—F-containing byproducts, forming more hydrolysis products in a matter of minutes (FIG. 23). As a result, even though 1 M NaPF₆ and KPF₆ based electrolytes in carbonate solvents show exceptional stability in the presence of H₂O, our ability to take advantage of this property will depend on the chemical reactions that take place in the electrolyte—one of the main concerns surrounds high voltage cathodes. For example, if the system contains EC and NMC811 and the voltage increases >3.8 V vs Li/Li⁺, EC solvent undergoes a dehydrogenation reaction that produces protons (EC→VC+2H⁺+2e⁻). As the battery continues to charge, more solvent is oxidized, more protons are produced, and a vicious catalytic cycle ensues. In Li batteries, proton production at the cathode has already been shown to accelerate PF₆⁻ decomposition by several orders of magnitude. Similar processes may occur in Na- and K-ion batteries that contain high voltage cathodes and experience HF-driven transition metal dissolution despite the fact that these salts show higher stability in non-protic conditions.

If solvent oxidation produces protons at high potential, the acid-catalyzed nature of PF₆⁻ decomposition suggests that as long as one uses a low voltage cathode in Na- and K-ion batteries (e.g., olivine, organic) then one may be able to mitigate the formation of HF in cost-effective NaPF₆/KPF₆-based electrolytes. In addition, our thermal stability data (FIG. 26) also suggests that there are opportunities for high temperature formation that may not be possible with LiPF₆ in these systems. However, we note that the use of low voltage cathodes in Na- and K-ion batteries sacrifices energy density, where these systems are already at a disadvantage compared to Li.

However, if one can either develop a Na- or K-ion battery that mitigates the formation of protons via electrolyte optimization and/or cathode design, these systems offer advantages compared to Li. First, without the continuous buildup of HF during electrochemical cycling, Na- and K-ion batteries provide an inherent safety advantage because protic species reduce at the anode to produce flammable H₂ gas. In fact, the results presented here may explain why commercial-scale Na-ion batteries do not flame during nail penetration tests, since H₂ is one of the main flammable gases in the battery and we expect these systems to have less HF that reduces to H₂. For example, although NMC811 has been shown to oxidize EC to produce protons, NMC622 and NMC111 are not as reactive.

Second, our experiments show that severe PF₆⁻ breakdown generates organofluorophosphates, monofluorophosphates, organophosphates, and phosphonates that have raised safety concerns beyond those presented by HF. All of these compounds can be inhaled upon battery venting, during burning/extinguishing, or released to the environment during recycling, with each class potentially leading to health complications for humans or the environment. When we examine the core structures that are formed during PF₆⁻ decomposition, we find OPF(OR)₂, OP(OR)₃, and R′OPO(OR)₂, which are similar to many known irreversible acetylcholinesterase inhibitors. Related compounds have broad applications, ranging from innocuous to insidious with varying toxicity, depending on the functional group appended to the core structure. For example, similar molecules are used as active ingredients in toothpaste, in the treatment of glaucoma, as broad-action herbicides/pesticides (like glyphosate), and as chemical nerve agents. Of particular concern are the phosphonates that exhibit a P—R bond, which are uniquely captured by NMR and, given the potential for enzymatic activity, warrant consideration of their formation and toxicity, especially for safety and recycling efforts. We recognize that these experiments were performed using higher water concentrations (˜11000 ppm) than those that are typically encountered during normal operating conditions, but because water is one of the most common tools in extinguishing battery fires, these data provides invaluable insight into managing faulty or hazardous battery systems, and how to deal with wastewater to ensure local environments are protected.

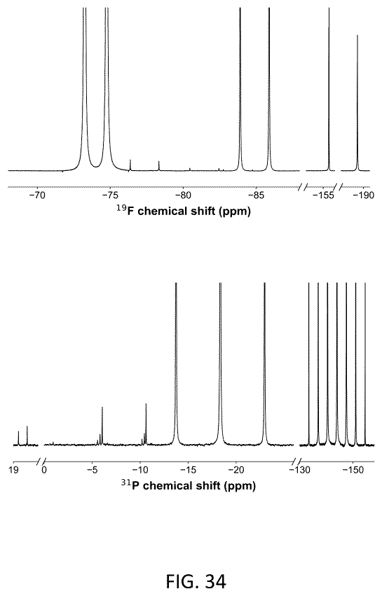

To mimic the conditions encountered during cycling, we constructed an additional electrolyte sample of 1 M LiPF₆ in EC:PC containing 200 ppm H₂O to match the amount of water produced during high voltage battery operation. FIG. 34 shows ¹⁹F and ³¹P NMR that were recorded after two and a half months where the breakdown products are HPO₂F₂ (0.14 M), HF (0.14 M), H₂PO₃F (2 mM), organofluorophosphates (˜0.6 mM), and phosphonates (˜0.007 mM). Organophosphates were below the level of detection, and the final amount of LiPF₆ was 0.86 M. The lower concentration of the products is expected due to the lower amount of water in the initial sample, but the identity of all the final products is the same.

### CONCLUSION

In situ NMR of 1 M XPF₆ electrolytes (X=Li, Na, K) in carbonate solvents show a clear periodic trend for the rate of PF₆⁻ hydrolysis where the acidity of the counterion accelerates decomposition in the presence of water. Upon hydrolysis, the primary decomposition product is HF, and once formed, the production of HF is autocatalytic where the hydrolysis of fluorophosphates proceeds through a proton-stabilized intermediate. Given that Na⁺ and K⁺ are weaker Lewis acids than Li⁺, NaPF₆ and KPF₆ are less prone to hydrolysis, even in the presence of large quantities of water. However, due to the acid-catalyzed nature of the PF₆⁻ hydrolysis reaction, it can be easily induced through the external addition of acid to Na and K electrolyte, indicating that these systems still degrade under cycling conditions that causes protons to evolve (e.g., solvent oxidation).

### Experimental Methods

### Materials

Lithium hexafluorophosphate (LiPF₆, >99.99%, battery grade), sodium hexafluorophosphate (NaPF₆, 98%), potassium hexafluorophosphate (KPF₆, >99%), hydrochloric acid (HCl, 37% w/w), ethylene carbonate (EC, >99%), and propylene carbonate (PC, >99%) were purchased from Sigma Aldrich. Deuterated dimethyl sulfoxide (DMSO-d₆>99.9%) was purchased from Cambridge Isotope Laboratories. Hydrofluoric acid (HF, 48-51% w/w) was purchased from Fisher Chemical.

Before use, LiPF₆, NaPF₆ and KPF₆ were separately dried in vacuo overnight at 100° C. before bringing into an Ar-filled glovebox (O₂<0.1 ppm, H₂O<0.5 ppm). EC and PC were mixed in equal parts by volume and stored with molecular sieves for at least 24 hours to remove residual water. This can result in H₂O<10 ppm in electrolyte solvents via Karl Fischer titration. Prior to use, DMSO-d₆ was dried over molecular sieves in an Ar-filled glovebox for at least 24 hours. Fresh, nanopure water was used to prepare all of the electrolyte solutions to monitor hydrolysis. All other materials were used as received.

### Sample Preparation

EC and PC were filtered using a PTFE filter attached to a syringe to remove residue from the molecular sieves and combined in a 50:50 ratio. LiPF₆, NaPF₆, or KPF₆ was added to the solvent to achieve a concentration of 1 M and the solution was vigorously shaken and left for 5 min to allow for salt dissolution. 600 μL of the 1 M LiPF₆, NaPF₆, or KPF₆ in EC:PC was then placed into a 3.65 mm fluorinated ethylene polypropylene copolymer (FEP) NMR tube liner (Wilmad LabGlass, dried at 60° C. overnight and temperature equilibrated in Ar-filled glovebox prior to use). 1.5 vol % fresh, nanopure H₂O was pipetted into the FEP liner. It is useful to use fresh water since distilled water left on the bench can react with CO₂ in the air to produce H₂CO₃ (carbonic acid), lowering the pH, in some cases as low as 5.5. This phenomenon is well-known and is described in most applications notes for pH meters to measure the pH of distilled water. Once prepared, the FEP liner was plugged with its PTFE cap and placed inside a 5 mm airtight glass J-Young NMR tube containing 0.1 mL of DMSO-d₆ (for locking and shimming).

An additional LiPF₆ sample was prepared which contained 200 ppm H₂O to compare the final product distribution after aging. Further, to test the influence of acid on the rate of hydrolysis, 1.5 vol % of 37% HCl was added, instead of water, to KPF₆ and NaPF₆ samples shown in FIG. 23. For the experiments where we directly detect HF with NMR (FIG. 29), a total of 50 μL of HF was added to 3.5 mL of nanopure water or 1 M LiPF₆ in ethylene carbonate:dimethyl carbonate (EC:DMC), LP30. The HF concentration was 0.33 M in water and 0.38 M in LP30. Then, 600 μL of the solution was placed into an FEP liner, which was then placed into a J-Young NMR tube containing 0.1 mL of DMSO-d₆ (for locking and shimming), and the ¹⁹F NMR spectra of HF in H₂O and LP30 were collected.

### In Situ NMR

All solution NMR experiments on the 1.5 vol % H₂O-containing samples were performed on a Bruker Avance III 400 spectrometer equipped with a triple resonance broadband observe (TBO) probe head. One-dimensional (1D)¹H (30° single pulse, 3 s recycle delay, 24 scans, internally referenced to the residual protons on ethylene carbonate at 4.2 ppm), ¹⁹F (30° single pulse, 10 s recycle delay, 32 scans, internally referenced to LiPF₆ at −74.0 ppm) and ³¹P (30° single pulse with WALTZ-16 ¹H decoupling, 10 s recycle delay, 128 scans, internally referenced to LiPF₆ at −144.0 ppm). NMR spectra were recorded on the sample periodically over the course of approximately one month. These NMR spectra were recorded sequentially, such that each time point in the resulting data had a ¹H, ¹⁹F and ³¹P data point attached. Data collected at all other time points is denoted in the captions.

To probe C—F environments in 1D ¹⁹F NMR (which may occur at higher shifts our standard sweep width in 1D ¹⁹F would detect), we shifted the irradiation frequency towards the C—F region (i.e., O1p set to −120 ppm in FIG. 33). Solution NMR experiments on the sample containing 200 ppm of H₂O were collected on a Bruker Ascend 500 spectrometer equipped with a broadband (BB) cryoprobe. One-dimensional (1D) ¹H (30° single pulse, 1.5 s recycle delay, 32 scans, internally referenced to the residual protons on ethylene carbonate at 4.2 ppm), ¹⁹F (30° single pulse, 10 s recycle delay, 64 scans, internally referenced to LiPF₆ at −74.0 ppm) and ³¹P (30° single pulse with WALTZ-16 ¹H decoupling, 10 s recycle delay, 128 scans, internally referenced to LiPF₆ at −144.0 ppm) NMR spectra were taken after 77 days of storage at room temperature after addition of 200 ppm H₂O. ¹⁹F NMR spectra of HF were recorded using 30° single pulse, 3 s recycle delay, and 32 scans.

Note that ¹H samples were not referenced to the residual DMSO from the deuterium lock—as is traditionally done—to preserve shift homogeneity over time. Salt concentration has a significant effect on chemical shift values, which means that as LiPF₆ concentration changes over the course of our experiments, our peaks of interest in the spectra will ‘drift’ with respect to the external reference DMSO peak (which is not immersed in salt). Thus, referencing to ethylene carbonate at 4.2 ppm ensures the peaks we are observing in our samples have consistent chemical shifts over time relative to one another.

Two-dimensional (2D)¹⁹F-³¹P heteronuclear multiple-quantum correlation (HMQC) (1024 time points, 1.5 s recycle delay, 2 scans per slice, spectral widths F₂ and F₁ were 11312 Hz and 34014 Hz respectively), ³¹P-³¹P correlation spectroscopy (COSY) (1024 time points, 2 s recycle delay, 32 scans per slice, spectral widths F₂ and F₁ were 32467 Hz and 32393 Hz respectively), and ¹H-³¹P HMQC (1024 time points, 1.5 s recycle delay, 4 scans per slice, spectral widths F₂ and F₁ were 4000 Hz and 19437 Hz respectively), and ¹⁹F-¹³C HMQC (1024 time points, 1.5 s recycle delay, 2 scans per slice, spectral widths F₂ and F₁ were 113636 Hz and 20125 Hz respectively) were recorded on the LiPF₆ electrolyte sample containing water after 71 days of storage.

### Plotting and Integration of Time-Series Data

All NMR spectra were analyzed in Python by importing the data with the Python package NMRglue. The areas of each signal in ¹⁹F and ³¹P 1D experiments were numerically integrated using an in-house algorithm. Areas of signals corresponding to the same chemical species (i.e. organofluorophosphates, organophosphates, phosphonates) were added together for FIGS. 4 and 5. Because no polyphosphate molecules existed, the integrated area of ³¹P should always equal 1 mol/L. Thus, we tracked all concentrations based on ³¹P integrated areas. To calculate HF concentration, we compared the integrated area of HF to the LiPF₆ doublet in ¹⁹F NMR of the same spectrum and scaled according to the LiPF₆ intensity in ³¹P NMR of the time-equivalent scan. Peak picking was done with the SciPy python package to get accurate shift values, but always qualitatively confirmed to ensure the correct peak was picked. For longer time periods, we report time using days because at most two scans were conducted in a single day and using hours is not justified. The exception to this is FIG. 23, where due to the much smaller time difference between ¹⁹F scans, we use minutes to measure time. We also report HF values with one less significant figure than the rest of ¹⁹F NMR shifts.

The percent accuracy (Q) of the integrated intensities for each nucleus can be calculated as follows:

$$Q = \frac{1 - {e}^{\frac{{T}_{r}}{{T}_{1}}}}{1 - [ {e}^{\frac{{T}_{r}}{{T}_{1}}} cos θ ]}$$

Where Tr is the repetition time (acquisition time+recycle delay), T1 is the spin-lattice relaxation time, and θ is the flip angle. For ¹⁹F, we used an acquisition time of 290 ms, based the sample T₁ on that of PF₆⁻=2.8±0.1 s, and used a flip angle of 30°, providing a Q of 98%. For ³¹P, we used an acquisition time of 2 s, based the sample T₁ on that of PF₆⁻=5.2±0.1 s, and used a flip angle of 30°, providing a Q of 91%. For ¹H, we used an acquisition time of 4 s, based the sample T₁ on that of EC=1.9±0.1 s, and used a flip angle of 30°, providing a Q of 98%.

### ASPECTS

The following Aspects are illustrative only and do not limit the scope of the present disclosure or the appended claims. Any part or parts of any one or more Aspects can be combined with any part or parts of any one or more other Aspects.

Aspect 1. An electrolyte, comprising: an amount of potassium hexafluorophosphate; at least one cyclic carbonate, the at least one cyclic carbonate optionally comprising at least one of ethylene carbonate and propylene carbonate; and at least one organic phosphate, the at least one organic phosphate optionally comprising at least one of trimethyl phosphate and triethyl phosphate. Without being bound to any particular theory or embodiment, the electrolyte can include KPF₆ at from about 0.5 to about 2.0 M.

Aspect 2. The electrolyte of Aspect 1, wherein the at least one cyclic carbonate comprises ethylene carbonate.

Aspect 3. The electrolyte of Aspect 1, wherein the at least one cyclic carbonate comprises propylene carbonate.

Aspect 4. The electrolyte of Aspect 1, wherein the at least one cyclic carbonate comprises ethylene carbonate and propylene carbonate.

Aspect 5. The electrolyte of Aspect 4, wherein the ethylene carbonate and propylene carbonate are present in a volume ratio of from about 0.5:1 to 1:0.5.

Aspect 6. The electrolyte of Aspect 5, wherein the ethylene carbonate and propylene carbonate are present in a volume ratio of 1:1.

Aspect 7. The electrolyte of any one of Aspects 1-6, wherein the organic phosphate comprises a trialkyl phosphate.

Aspect 8. The electrolyte of Aspect 7, wherein the at least one trialkyl phosphate comprises at least one of trimethyl phosphate and triethyl phosphate.

Aspect 9. The electrolyte of any one of Aspects 1-8, wherein the organic phosphate is present at from about 10 vol % to about 50 vol % of the electrolyte.

Aspect 10. The electrolyte of any one of Aspects 1-9, wherein the potassium hexafluorophosphate is present at from about 0.5 M to about 1.5 M, optionally at about 1.0 M.

Aspect 11. The electrolyte of any one of Aspects 1-10, wherein the electrolyte is free of linear carbonates.

Aspect 12. The electrolyte of any one of Aspects 1-11, further comprising any one or more of potassium nitrate and potassium bis(fluorosulfonyl)imide (KFSI).

Aspect 13. The electrolyte of any one of Aspects 1-12, wherein the electrolyte is nonflammable.

Aspect 14. The electrolyte of any one of Aspects 1-13, wherein vapor evolved when the electrolyte is heated to 200° C. is nonflammable.

Aspect 15. An electrical cell, comprising: the electrolyte according to any one of Aspects 1-14; and an electrode, the electrode contacting the electrolyte.

Aspect 16. The electrical cell of Aspect 15, wherein the electrode comprises at least one of graphite and carbon.

Aspect 17. The electrical cell of Aspect 16, wherein the electrode comprises graphite.

Aspect 18. The electrical cell of any one of Aspects 15-17, wherein the electrical cell is comprised in a vehicle or tool.

Aspect 19. The electrical cell of any one of Aspects 15-17, wherein the electrical cell is comprised in an energy storage system.

Aspect 20. The electrical cell of Aspect 19, wherein the energy storage system is free of fire suppression components.

Aspect 21. A method, comprising charging or discharging an electrical cell according to any one of Aspects 15-20.

Aspect 22. A method, comprising at least one of (1) replacing at least some of the LiPF₆ of a battery electrolyte that comprises LiPF₆ with any one or more of NaPF₆ and KPF₆ and (2) adding any one or more of NaPF₆ and KPF₆ to a battery electrolyte that comprises LiPF₆. As an example, a user may identify a battery electrolyte that includes LiPF₆ and then replace some or all of that LiPF₆ with one or both of NaPF₆ and KPF₆. This can be accomplished by, for example, draining some or all of the electrolyte from the battery and replacing the drained electrolyte with one or both of NaPF₆ and KPF₆. One can also add one or both of NaPF₆ and KPF₆ to an electrolyte that comprises LiPF₆ so as to reduce the relative presence of LiPF₆ in the electrolyte.

Aspect 23. A method, comprising: any one or more of separating, disposing, or at least partially neutralizing any one or more of HF, HPO₂F₂, H₂PO₃F, an organofluorophosphate, a monofluorophosphate, an organophosphate, and a phosphonate evolved from operating an electrical cell that includes as an electrolyte any one or more of LiPF₆, NaPF₆, and KPF₆. Without being bound to any particular theory or embodiment, one can identify the presence of HF, HPO₂F₂, H₂PO₃F, an organofluorophosphate, a monofluorophosphate, an organophosphate, and a phosphonate in the electrical cell and then separate the HF, HPO₂F₂, H₂PO₃F, an organofluorophosphate, a monofluorophosphate, an organophosphate, and a phosphonate from the electrical cell. One can also, for example, collect used electrolyte from the electrical cell—which used electrolyte can include HF, HPO₂F₂, H₂PO₃F, an organofluorophosphate, a monofluorophosphate, an organophosphate, and a phosphonate—and then treat such electrolyte in a manner that renders less harmful the HF, HPO₂F₂, H₂PO₃F, organofluorophosphate, monofluorophosphate, organophosphate, or phosphonate.

Aspect 24. A method, comprising: mitigating the effects of any one or more of HF, HPO₂F₂, H₂PO₃F, an organofluorophosphate, a monofluorophosphate, an organophosphate, and a phosphonate evolved from operating an electrical cell that includes as an electrolyte any one or more of LiPF₆, NaPF₆, and KPF₆. Such mitigation can include, for example, collecting used electrolyte from the electrical cell—which used electrolyte can include HF, HPO₂F₂, H₂PO₃F, an organofluorophosphate, a monofluorophosphate, an organophosphate, and a phosphonate—and then treating such electrolyte in a manner that renders less harmful the HF, HPO₂F₂, H₂PO₃F, organofluorophosphate, monofluorophosphate, organophosphate, or phosphonate.

What is claimed:

1. An electrolyte, comprising:
an amount of potassium hexafluorophosphate;
at least one cyclic carbonate,
the at least one cyclic carbonate optionally comprising at least one of ethylene carbonate and propylene carbonate; and
at least one organic phosphate,
the at least one organic phosphate optionally comprising at least one of trimethyl phosphate and triethyl phosphate.

2. The electrolyte of claim 1, wherein the at least one cyclic carbonate comprises ethylene carbonate.

3. The electrolyte of claim 1, wherein the at least one cyclic carbonate comprises propylene carbonate.

4. The electrolyte of claim 1, wherein the at least one cyclic carbonate comprises ethylene carbonate and propylene carbonate.

5. The electrolyte of claim 4, wherein the ethylene carbonate and propylene carbonate are present in a volume ratio of from about 0.5:1 to 1:0.5.

6. The electrolyte of claim 1, wherein the organic phosphate comprises at least one trialkyl phosphate.

7. The electrolyte of claim 6, wherein the at least one trialkyl phosphate comprises at least one of trimethyl phosphate and triethyl phosphate.

8. The electrolyte of claim 1, wherein the organic phosphate is present at from about 10 vol % to about 50 vol % of the electrolyte.

9. The electrolyte of claim 1, wherein the potassium hexafluorophosphate is present at from about 0.5 M to about 1.5 M, optionally at about 1.0 M.

10. The electrolyte of claim 1, wherein the electrolyte is free of linear carbonates.

11. The electrolyte of claim 1, further comprising any one or more of potassium nitrate and potassium bis(fluorosulfonyl)imide (KFSI).

12. The electrolyte of claim 1, wherein (a) the electrolyte is nonflammable, (b) vapor evolved when the electrolyte is heated to 200° C. is nonflammable, or both (a) and (b).

13. An electrical cell, comprising:
the electrolyte according to claim 1; and
an electrode,
the electrode contacting the electrolyte.

14. The electrical cell of claim 13, wherein the electrode comprises at least one of graphite and carbon.

15. The electrical cell of claim 14, wherein the electrode comprises graphite.

16. The electrical cell of claim 13, wherein the electrical cell is comprised in any one or more of a vehicle, a tool, and an energy storage system.

17. The electrical cell of claim 16, wherein the electrical cell is comprised in an energy storage system free of fire suppression components.

18. A method, comprising charging or discharging an electrical cell according to claim 13.

19. A method, comprising at least one of (1) replacing at least some of the LiPF₆ of a battery electrolyte that comprises LiPF₆ with any one or more of NaPF₆ and KPF₆ and (2) adding any one or more of NaPF₆ and KPF₆ to a battery electrolyte that comprises LiPF₆.

20. A method, comprising:
(a) any one or more of separating, disposing, or at least partially neutralizing any one or more of HF, HPO₂F₂, H₂PO₃F, an organofluorophosphate, a monofluorophosphate, an organophosphate, and a phosphonate evolved from operating an electrical cell that includes as an electrolyte any one or more of LiPF₆, NaPF₆, and KPF₆, or
(b) mitigating the effects of any one or more of HF, HPO₂F₂, H₂PO₃F, an organofluorophosphate, a monofluorophosphate, an organophosphate, and a phosphonate evolved from operating an electrical cell that includes as an electrolyte any one or more of LiPF₆, NaPF₆, and KPF₆.
